(19) United States
(12) Patent Application Publication
(10) Pub. No.: US 2007/0029344 A1
(43) Pub. Date: Feb. 8, 2007

(54) Dispenser bottle for liquid detergents that are comprised of at least two partial compositions

(76) Inventors: Tatiana Schymitzek, Krefeld (DE); Carlos Malet, Sant Boi de Llobregat (ES); Mercedes Mendoza Cruz, Barcelona (ES); Daniela Kurandt, Dusseldorf (DE); Fabian Sieben, Leverkusen (DE)

Correspondence Address: PAUL & PAUL, 2000 MARKET STREET, PHILADELPHIA, PA, 19103-3229, US

(21) Appl. No.: 11/506,092

(22) Filed: Aug. 17, 2006

Related U.S. Application Data
(63) Continuation of application No. PCT/EP05/01314, filed on Feb. 10, 2005.

(30) Foreign Application Priority Data
Feb. 17, 2004 (DE) DE 102004007860.2

(51) Int. Cl. B67D 5/56; A62C 13/62; A62C 13/66

(52) U.S. Cl. 222/129; 239/302; 239/303

(57) ABSTRACT

The invention relates to a dispenser bottle for a liquid aqueous washing composition which consists of at least two, preferably exactly two, part-compositions kept separate from one another. The dispenser bottle has a first receiving vessel (1) and at least one, preferably exactly one, second receiving vessel (2) and the first receiving vessel (1) contains a first part-composition and the second receiving vessel (2) a second part-composition. The two receiving vessels (1, 2) are either designed separately or connected to one another or designed together in one piece, The receiving vessels (1, 2) each have an outlet (3, 4) for the part-composition. The outlets (3, 4) are arranged adjacently to one another such that the two part-compositions can be applied in a common application field (5) of an application region. The first part-composition comprises water, hydrogen peroxide and surfactant and has an acidic pH and the second part-composition has an alkaline pH. In this dispenser bottle, the outlets (3; 4) are each equipped with at least one, preferably with exactly one, expulsion nozzle (6, 7), so that the part-compositions are not mixed with one another until after they leave the expulsion nozzles (6, 7).

### CROSS-REFERENCE TO RELATED APPLICATIONS

This application is a continuation under 35 U.S.C. § 365(c) and 35 U.S.C. § 120 of International Application No. PCT/EP2005/001314, filed Feb. 10, 2005. This application also claims priority under 35 U.S.C. § 119 of German Patent Application No. 10 2004 007 860.2, filed Feb. 17, 2004. The International Application and the German Application are incorporated herein by reference in their entireties.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The invention relates to a dispenser bottle for a liquid aqueous washing composition which consists of at least two part-compositions kept separate from one another, said dispenser bottle having at least two receiving vessels for part-compositions thus storable separately from one another.

(2) Description of Related Art, Including Information Disclosed Under 37 C.F.R. §§ 1.97 and 1.98

It is known from some fields of application, especially in the sector of surface cleaning, to use active substance fluids which should or must be stored separately from one another. These active substance fluids should meet one another only briefly before or in the course of application to the application region, for example, a floor, the surface of a toilet bowl, etc. Examples thereof are chlorinated bleaches, cleaners, descalers and disinfectants (for example, WO 98/21308 A2). Active substance fluids of the type in question are also applied, for example, to surfaces in the bathroom or in other hygienically sensitive regions.

Active substance fluids are stored in different receiving vessels especially when they are not storage-stable together with one another. However, other reasons for separate storage of active substance fluids which are to be applied together are also known, for example, different colors which are intended to communicate different functions of the active substance fluids, different light sensitivities, etc.

The dispenser bottle for at least two different active substance fluids which are not storage-stable together, from which the invention proceeds (WO 98/21308 A2 and U.S. Pat. No. 5,398,846 A), has a bottle which has two separate chambers which form the receiving vessel and is provided at the upper end with immediately adjacent outlets for the active substance fluids in the two receiving vessels. In one receiving vessel is disposed a first aqueous solution and in the second receiving vessel a second aqueous solution. The concentration of the components in the two aqueous solutions is selected such that, when a certain amount of the first aqueous solution is mixed with a certain amount of the second aqueous solution, the result is the acidic bleach solution desired in this prior art.

The disclosure content of the two aforementioned publications which had not been published at the priority date of the present application is incorporated by reference into the disclosure content of the present patent application.

The dispenser bottle of the prior art outlined above, which forms the starting point, has a pump device which can be attached to the outlets of the two receiving chambers of the dispenser bottle. In the pump device, the active substance fluids are combined with one another and expelled from an expulsion nozzle in a common spray jet. The active substance fluids are thus mixed with one another before they leave the expulsion nozzle.

A similar dispenser bottle in which cross-contamination between the two receiving vessels can reliably be substantially prevented is likewise known (WO 91/04923 A1). In this dispenser bottle, no pump spray device is provided, and the outlets are instead simply open and provided with pouring spouts and can be closed again by means of a closure cap. However, this dispenser bottle is unsuitable for spray application.

Irrespective of this, the disclosure content of these publications which were unpublished at the priority date of the present application is also incorporated by reference in the disclosure content of the present patent application for details of design.

Specifically intended for the cleaning of toilet bowls is a dispenser bottle for an active substance fluid, comprising a receiving vessel made of flexible plastic and an expulsion nozzle (EP 0911 616 B1), the active substance fluid being applied optimally in the toilet bowl, especially below its rim, by designing the expulsion nozzle as an angled dosage tube.

In the case of laundry detergents in liquid form, especially when they comprise water, chemical incompatibility of the individual ingredients can lead to negative interactions of these ingredients with one another and to a decrease in their activity and hence to a decrease in the washing performance of the composition overall, even when it is stored only relatively briefly. This activity decrease relates in principle to all washing composition ingredients which perform chemical reactions in the washing process in order to contribute to the wash result, especially bleaches, although enzymes, surfactant or sequestering ingredients which are responsible for dissolution processes or complexing steps, do not have unlimited storage stability in aqueous systems, especially in the presence of the chemically reactive ingredients mentioned. One possible remedy arises, for example, from the fact that the reactivity of the chemically active ingredients is not equal at all pH values, so that appropriate adjustment of the pH of the composition allows the damaging action of one ingredient or its decomposition reaction to be minimized. However, a difficulty arises from the fact that the minimum of the reactivity of the chemically active ingredients is generally not at the same pH, and stabilization via the pH is therefore normally not possible simultaneously for all ingredients. A further difficulty arises from the fact that the pH which should as far as possible be at the reactivity minimum in the course of storage must change under use conditions of the composition, so that the reactivity of the chemically active ingredients can become higher under the wash conditions and thus makes them capable of making their contribution to the wash result.

To solve this problem, various proposals have been made in the prior art not to incorporate all washing composition ingredients desirable for a good wash result simultaneously into a liquid washing composition but rather to provide several components to the user of the washing composition which he or she should combine only briefly before or during the washing operation and which comprise in each case only mutually compatible ingredients which are used together under the use conditions.

For instance, International Patent Application WO 00/61713 A1 discloses a liquid washing composition which consists of at least two liquid part-compositions, the active substance fluids being stored separately from one another in a vessel with at least two chambers (receiving vessels) and of which at least one comprises an imine or oxaziridine bleach activator and at least one other an alkalizing agent, at least one of the part-compositions comprising a peroxygen bleach and each part-composition having a pH leading to stability. When the part-compositions are mixed, the alkalizing agent increases the pH of the end composition, so that bleach and bleach activator react effectively with one another.

The European patent EP 0 807 156 B1 discloses a dispenser with two chambers, whose first chamber contains an aqueous composition of hydrogen peroxide or of an organic peracid having a pH above 2 and below 7, and whose second chamber contains an acidic component and from which the contents are discharged together or successively onto a surface such that the resulting mixture has a pH of at most 2.

International Patent Application WO 94/15465 A1 describes a two-pack system composed of firstly an aqueous aliphatic peracid and secondly an aqueous hydrogen peroxide solution which comprises corrosion inhibitor, peracid stabilizer and/or hydrogen peroxide stabilizer. The two solutions are combined to obtain a disinfectant.

German Patent Application DE 100 24 251 A1 proposes the storage of a bleach which, in a first component, consists of an aqueous 1- to 40 percent by weight aqueous iminoperoxocarboxylic acid dispersion and, in a second component, of a substance mixture which activates the first component, in a correspondingly separate manner in a double-chamber bottle, and the mixing of the two components only in the course of use. The second component, also referred to as a pH-regulating buffer solution in this publication, consists of an aqueous solution of sodium hydrogencarbonate and sodium carbonate which has been thickened with the aid of methylcellulose.

### BRIEF SUMMARY OF THE INVENTION

The teaching is thus based on the problem of specifying a dispenser bottle for a liquid washing composition which consists of at least two part-compositions (active substance fluids) kept separate from one another, said dispenser bottle having at least two receiving vessels for the at least two part-compositions and being producible inexpensively and manageable easily by a user, while allowing the at least two part-compositions to be applied separately from one another but such that they meet in an application field.

The objective detailed above is solved by a dispenser bottle for a liquid aqueous washing composition which consists of at least two, preferably exactly two, part-compositions kept separate from one another, the dispenser bottle having a first receiving vessel (1) and at least one, preferably exactly one, second receiving vessel (2) and the first receiving vessel (1) containing a first part-composition and the second receiving vessel (2) a second part-composition, the two receiving vessels (1, 2) either being designed separately or connected to one another or designed together in one piece, the receiving vessels (1, 2) each having an outlet (3, 4) for the part-composition and the outlets (3, 4) being arranged adjacently to one another such that the two part-compositions can be applied in a common application field (5) of an application region, the outlets (3, 4) each further being equipped with at least one, preferably with exactly one, expulsion nozzle (6, 7), so that the part-compositions are not mixed with one another until after they leave the expulsion nozzles (6, 7), the dispenser bottle being characterized in that the first part-composition comprises water, hydrogen peroxide and surfactant and has an acidic pH and the second part-composition has an alkaline pH.

The invention further provides for the use of such a dispenser bottle for the application of washing compositions.

The receiving vessels are preferably designed as compressible containers. Compression of the receiving vessels by the hand of a user thus generates the necessary internal pressure in the receiving vessels to expel the active substance fluids from the expulsion nozzles provided separately in each case. The required pressure can also be generated by gravity when the product release is not discharged horizontally or not upward counter to gravity but rather downward, as in the case of application of textile treatment compositions to contaminated textiles for stain removal or in the case of introduction of washing compositions into a washing machine or its detergent drawer. The active substance fluids thus mix only after they leave the expulsion nozzles in the application field. As a result, the desired product to be applied forms from the two active substance fluids in the course of application, i.e. especially the washing composition which displays the desired action in the application field.

The claimed dispenser bottle achieves the result outlined above with a constructively very simple and readily manageable solution, in particular, without a pump spray device. The claimed dispenser bottle is thus highly suitable for use as a mass market product.

In the context of the teaching of the present patent application, active substance fluids are understood to mean all liquid and other free-flowing media, from mobile to viscous through gel-like up to and including pasty substances. It is also possible for pulverulent active ingredients and those in piece form, such as in granule form, to be applied with the inventive dispenser bottle. In this context, what is of significance is firstly the viscosity of the active substance fluids and secondly flowability of the active substances for the particular application of interest, and particularly also the thixotropy of the active substance fluids (for an explanation of the term thixotropy, the phenomenon that certain active substance fluids liquefy in the course of action of mechanical forces, but solidify again after the mechanical stress has ended, in some cases with a considerable time delay, i.e. have a viscosity dependent upon the action of mechanical forces; see Römpp Lexikon Chemistry, 10th Edition, Georg Thieme Verlag, Stuttgart, 1999, Volume 6, page 4533).

Preferred configurations and further developments of the teaching form the subject matter of the subclaims.

Particular and independent significance is attributable to a configuration for which the shape and the dimensions of the expulsion nozzles and the properties, in particular, the viscosities and/or the thixotropy, of the active substance fluids are adjusted relative to one another such that—with average pressure from the hand of a user and/or by virtue of gravity—the fluid streams overlap at a certain, pre-calculated distance. In a particular embodiment, the nozzle channels of the expulsion nozzles are aligned essentially parallel to one another, but each have a cross-sectional constriction arranged asymmetrically with respect to the overall flow cross-section. The cross-sectional constrictions are arranged on the sides of the nozzle channels facing one another such that the active substance fluids exiting under pressure have a swirl directed toward one another. This means that, as a result of the skillful design of the expulsion nozzles, the streams of the active substance fluids exiting from the expulsion nozzles deliberately flow toward one another in an arc-like manner and meet one another at a distance from the expulsion nozzles which varies somewhat as a function of the exit flow pressure. In that case, the application field of the application region may be here. This configuration with the cross-sectional constrictions has particular significance especially when the active substance fluids are essentially the same type of thixotropic active substance fluids.

The swirl effect is also caused when the orifices of the nozzle channels of the expulsion nozzles are canted with respect to one another, i.e. the orifice planes of the nozzle channels are angled with respect to one another, the inner section of the wall with respect to the longitudinal axis of the nozzle channel being longer than the outer section of the wall with respect to the longitudinal axis of the nozzle channel.

Further embodiments and developments are otherwise evident from the further subclaims.

### BRIEF DESCRIPTION OF THE SEVERAL VIEWS OF THE DRAWINGS

The invention will now be illustrated in detail with reference to a drawing which shows merely working examples. In the drawing,

FIG. 1a shows, in a perspective view, a first working example of an inventive dispenser bottle,

FIG. 1b shows, in a perspective view, a second working example of an inventive dispenser bottle,

FIG. 2a shows the dispenser bottle from FIG. 1a from the side,

FIG. 2b shows the dispenser bottle from FIG. 1b from the side,

FIG. 3 shows the dispenser bottle from FIG. 1a in a representation corresponding to FIG. 2a, but without nozzle head,

FIG. 4a shows, in a representation corresponding to FIG. 3, the dispenser bottle in a view from the narrow side,

FIG. 5a shows the dispenser bottle in a side view according to FIG. 2a, the closure cap for the expulsion nozzles removed,

FIG. 5b shows the dispenser bottle in a side view according to FIG. 2b, the closure cap for the expulsion nozzles removed,

FIG. 6a shows the dispenser bottle in a view from the back, as in FIG. 5a without closure cap,

FIG. 6b shows the dispenser bottle in a view from the back, as in FIG. 5b without closure cap,

FIG. 7 shows the dosage head of the dispenser bottle from FIG. 6 in a side view,

FIG. 8 shows the dosage head from FIG. 7 in section,

FIG. 9 shows the dosage head from FIG. 7 in section at right angles to the section from FIG. 8,

FIG. 10 shows, in a representation corresponding to FIG. 9, the dosage head, now with closure cap attached,

FIG. 11a shows the jet diagram of the active substance fluids in a first working example of an inventive dispenser bottle,

FIG. 11b shows the jet diagram of the active substance fluids in a second working example of an inventive dispenser bottle,

FIG. 12 shows the jet diagram of the active substance fluids in a further working example of an inventive dispenser bottle with expulsion nozzles with obliquely ending dosage channels,

FIG. 12a shows the dosage channel in section at the level of the cross-sectional constriction in a further working example and

FIG. 12b shows, correspondingly, the dosage channel in a third working example,

FIG. 13 shows a closure cap with positioning aid, and

FIG. 14 shows a dispenser bottle with a closure cap according to FIG. 13.

### DETAILED DESCRIPTION OF THE INVENTION

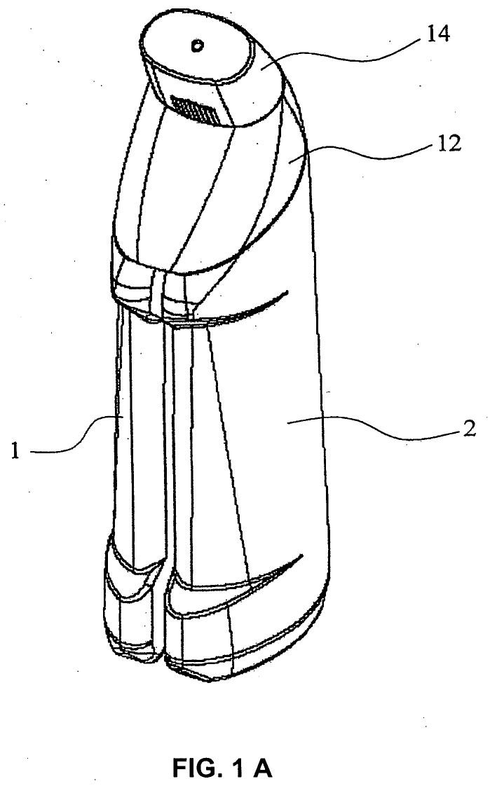

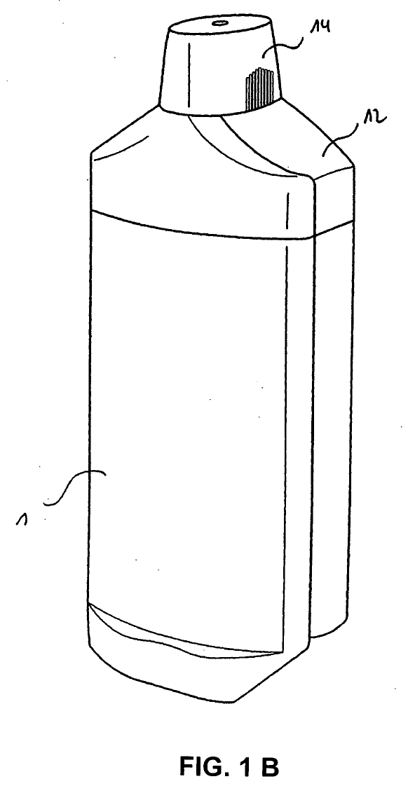

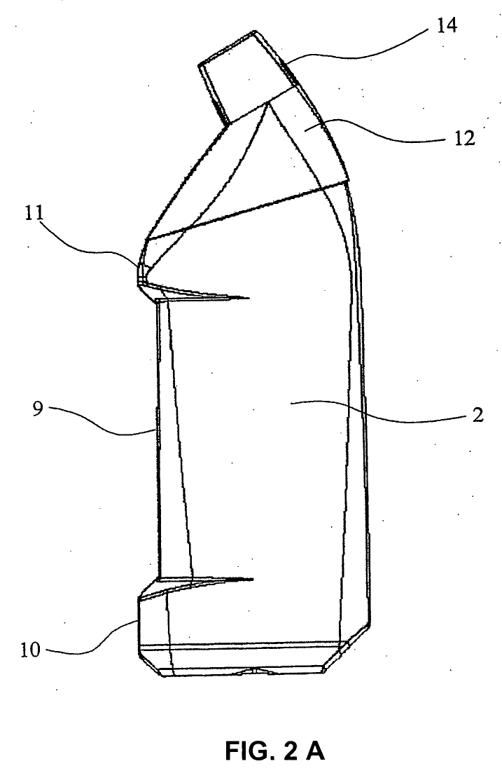

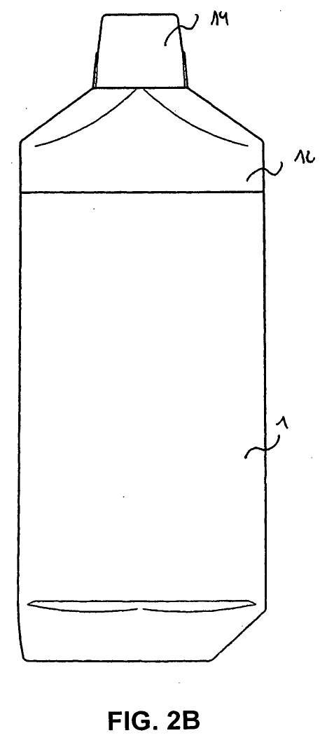

The invention provides a dispenser bottle as shown in perspective view in FIGS. 1a and 1b, and in side view in FIGS. 2a and 2b. Seen at the left hand side is a first receiving vessel 1 for a first part-composition (a first active substance fluid) and, at the right hand side, a second receiving vessel 2 for a second part-composition (a second active substance fluid). For the teaching of the invention, it is in principle the case that more than two receiving vessels 1, 2 may also be provided, for example, three receiving vessels for three part-compositions (active substance fluids) or even four receiving vessels for four part-compositions (active substance fluids), which are intended to meet one another in the application region.

The active substance fluids will frequently be active substance fluids which are not storage-stable together; but this is not an obligatory prerequisite for the teaching of the invention. Reference may be made to the remarks above. It is equally possible to make reference to the remarks above with regard to the definition of the term “active substance fluid” in the context of this patent application and to the particular, preferred properties of such active substance fluids.

The two receiving vessels 1, 2 are either designed separately and connected to one another, for example, by adhesive bonding or snap-fitting or another connecting element or, as in the working examples shown, designed in one piece together. In this regard, for the various process variants which can be selected here, reference may be made to the prior art cited at the outset. In fact, preference is given to a dispenser bottle in which the two receiving vessels 1, 2 are designed in one piece together.

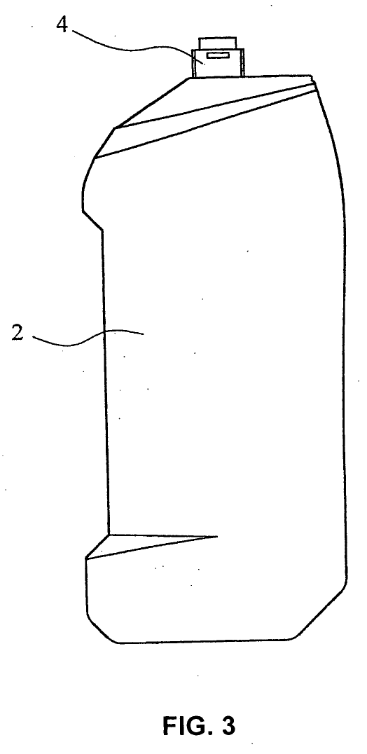

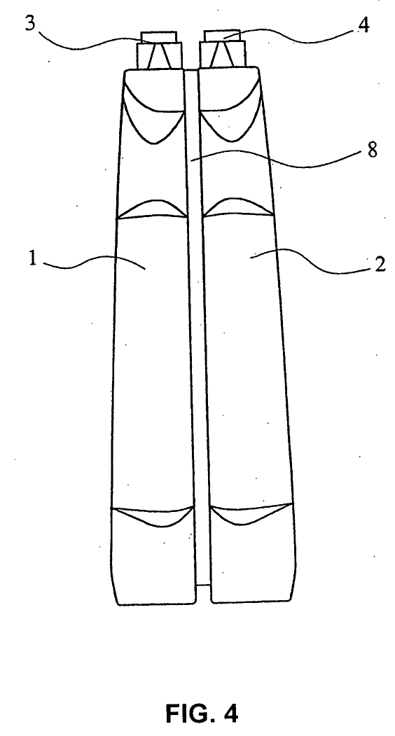

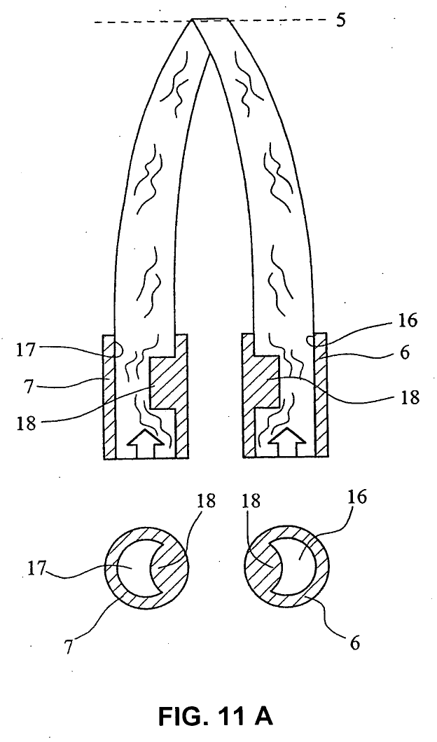

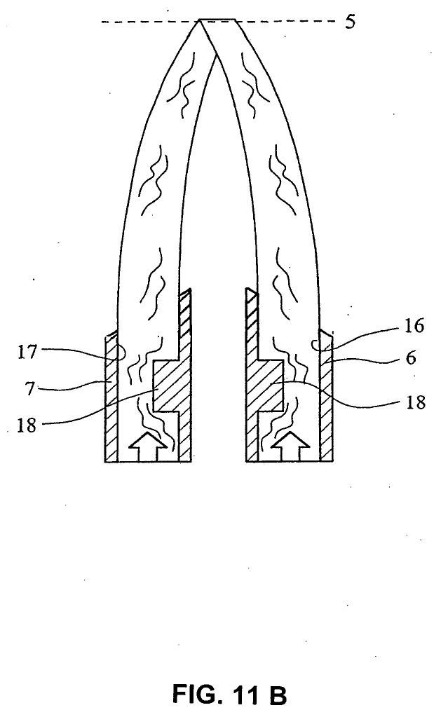

FIGS. 3 and 4 show the receiving vessels 1, 2 for the first embodiment of the dispenser bottle according to FIGS. 1a and 2a separately. It can be seen that the receiving vessels each have an outlet 3, 4 for the particular active substance fluid. The outlets 3, 4 are arranged adjacently to one another such that the two active substance fluids can be applied in a common application field 5, indicated in FIG. 11, of a larger application region. The particular significance of this external mixing of the active substance fluids from the two receiving vessels 1, 2 is referred to in detail in the general part of the description, and reference may be made thereto. For the embodiment of the dispenser bottle according to FIGS. 1b and 2b, the receiving vessels have not been shown separately; the only difference would be that they do not have any holding region, since the application is effected by tilting and the liquid exits owing to gravity.

Hereinafter, the inventive dispenser bottle is always illustrated as if there were only two receiving vessels 1, 2 for two active substance fluids. The statement explained at the outset, that it is also possible to use a plurality of receiving vessels, must be borne in mind because the remarks are also intended to apply to such multivessel dispenser bottles. The liquid washing composition present in the dispenser bottle is also explained as if it were to consist only of two part-compositions, although here too it must be remembered that it may also contain several part-compositions. It is advantageous when the number of receiving vessels 1, 2 corresponds to the number of part-compositions, so that a different part-composition is present in each receiving vessel 1, 2. If desired, the number of receiving vessels 1, 2 may, however, also exceed the number of part-compositions, so that an identical part-composition is present in more than one receiving vessel 1, 2.

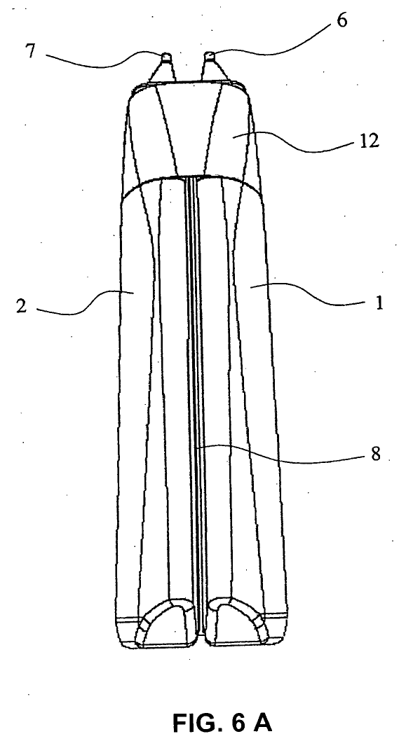

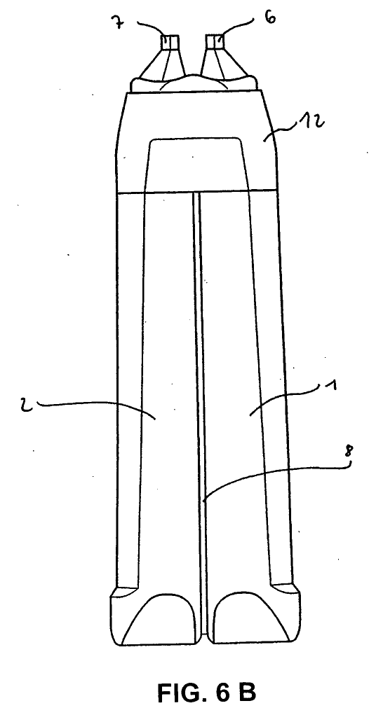

It is essential for the inventive dispenser bottle that the receiving vessels 1, 2 are provided with in each case one outlet 3, 4 with in each case at least one, preferably with exactly one, expulsion nozzle 6, 7, so that the active substance fluids are mixed with one another only after they leave the expulsion nozzles 6, 7. For the dispenser bottle according to the first embodiment (FIG. 1a), it is also essential that the receiving vessels 1, 2 are designed as compressible vessels, since they are preferably used for product release counter to gravity. The expulsion nozzles 6, 7 are preferably tilted with respect to the longitudinal axis of the receiving vessels 1, 2. For the dispenser bottle according to the second embodiment (FIG. 2), it is also essential that the expulsion nozzles 6, 7 run parallel in the direction of the receiving vessels 1, 2, since this dispenser bottle is preferably used to apply washing composition into the detergent drawer of a washing machine or a dosage aid for the drum of a washing machine or directly onto the textile to be cleaned by the force of gravity. The receiving vessels 1, 2 can be designed as compressible vessels. The expulsion nozzles 6, 7 can be seen firstly in FIGS. 6a and 6b, and otherwise also in FIG. 8 and, shown schematically, in FIGS. 11a, b.

As a result of the claimed embodiment of the dispenser bottle, the pressure to force the active substance fluids out of the receiving vessels 1, 2 by the hand of a user or by virtue of gravity is applied after tilting by more than 90°. The active substance fluids leave the expulsion nozzles 6, 7 under pressure, to which they flow from the outlets 3, 4 of the two receiving vessels 1, 2. Only after they leave the expulsion nozzles 6, 7, depending on the pressure exerted by the user, the meeting of the streams of the active substance fluids and their mixing arise at a certain distance to give the product to be applied to the application region.

The shown and preferred working example according to FIGS. 1a, 2a also shows that the receiving vessels 1, 2 consist of a material with resilient characteristics and/or have a shape which supports reset to the original shape. In particular, it is advisable to produce the receiving vessels 1, 2 from an elastically resilient polymer material. Such a material for the receiving vessels 1, 2 may be, for example, a polyolefin, especially a polypropylene (PP), a polyethylene (PE), a polyvinyl chloride (PVC) or a polyethylene terephthalate (PET), especially a glycol-modified polyethylene terephthalate (PETG). In this regard, reference may once again be made to the plastic spray bottle of EP 0 911 616 B1 already explained at the outset. Such materials are also suitable for the present application.

What is of interest in the embodiment of the receiving vessels 1, 2 illustrated above is that, as a result of the specific geometry of the receiving vessels 1, 2 in conjunction with the material used, optimal compressibility can be combined with a uniform back-suction effect for the active substance fluids. A uniform, effective back-suction effect for the active substance fluids from the expulsion nozzles 6, 7 back into the receiving vessels 1, 2 is of significance for clear product breakoff at the outer ends of the expulsion nozzles 6, 7 on completion of active substance fluid dosage.

Overall, the use of plastic containers with appropriate resilient characteristics is inexpensive and nevertheless allows effective dosage of the active substance fluids in the desired manner outlined further above without premature mixing.

The working examples of an inventive dispenser bottle shown in the drawings show specifically equal volumes and a shape identical in mirror image for the receiving vessels 1, 2. In principle, it is also possible to provide for different volumes when the shaping, wall thickness and material selection of the receiving vessels 1, 2 achieve the effect that the desired dosage of the active substance fluids from the receiving vessels 1, 2 is then different. Typical volumes of receiving vessels 1, 2 in the domestic application sector are between 50 ml and 1,500 ml, a preferred range being between 300 ml and 500 ml for each of the receiving vessels 1, 2. Of course, this is application-specific and dependent upon the active substance fluids.

The preferred working examples shown in FIGS. 1a and 1b also show, especially in FIG. 4, but also in FIGS. 6a and 6b, that the receiving vessels 1, 2 are designed as in each case complete containers and are only connected to one another via at least one, preferably exactly one, connecting element 8 formed between the receiving vessels 1, 2. The connecting element 8 is preferably shaped integrally onto the inner sides of the receiving vessels 1, 2 facing one another, in particular, for example, formed simultaneously with the receiving vessels 1, 2 in a blow-molding process. It is particularly appropriate when the connecting element 8 is arranged in about the middle and extends essentially—optionally with interruptions—over the full length of the receiving vessels 1, 2. The connecting element 8 thus forms a reinforcing element for the walls of the receiving vessels 1, 2 facing one another, stabilizes them and leads simultaneously to the formation of an abutment for the compressive forces exerted by the hand of the user. Overall, the receiving vessels 1, 2 should each have such a cross-section that they can be grasped, at least for the most part, by the hand of a user.

The blow-molding process has already been addressed beforehand as an appropriate process for producing the receiving vessels 1, 2. With appropriate modification, especially of the blow-molding process, it is possible that the receiving vessels 1, 2 designed together in one piece have a different transparency and/or a different color. In particular, it can be advisable, in spite of one-piece design, for one receiving vessel to have an opaque design and the other receiving vessel to have a transparent design, or, in the case of a plurality of receiving vessels, to design the receiving vessels in different color. It has been found that some active substance fluids are light-sensitive. Other active substance fluids to be applied in conjunction with the particular active substance fluid are less light-sensitive. An opaque color of the receiving vessel intended for the more light-sensitive active substance fluid eliminates problems here.

With regard to the handling by a user, the dispenser bottle shown in the drawings according to FIGS. 1a, 2a has the further feature that a holding region 9 to be grasped by the hand of a user is formed and/or indicated by special edge moldings 10, 11 and/or surface configurations on the receiving vessels 1, 2. This can be seen particularly well in FIGS. 1 and 2. The recessed grip provides a positive inducement to grasp the dispenser bottle from here with the hand. The dispenser bottle has a certain position with respect to the hand of the user which is predefined by the edge moldings 10, 11. Useful surface configurations also include, for example, corrugations, different colors, etc.

With regard to the dimensions, it has been found to be appropriate not to allow the receiving vessels 1, 2 to become too large in order not to hinder manageability. Preferred dimensions are such that the receiving vessels 1, 2 have, in cross-section, in the holding region 9 to be grasped by the hand of a user, an outer circumference of from approx. 18 to approx. 30 cm, preferably of from approx. 20 to approx. 28 cm, in particular, of from approx. 22 to approx. 26 cm, very particularly of approx. 24 cm.

The volume of the receiving vessels (1, 2) is guided, for example, by the weight or volume fraction of the active substances in the overall formulation of the washing composition present therein or the type of formulation of these active substances, for example, in the form of the pure substance, as a solution or dispersion. In a preferred embodiment, all receiving vessels (1, 2) have the same size, their volume being preferably between 10 and 2,000 ml, preferably between 20 and 1,500 ml, more preferably between 50 and 1,000 ml and in particular, between 100 and 800 ml. Inventive dispenser bottles are suitable for the repeated dosage of machine washing compositions; for this purpose, they accordingly contain preferably at least two, but in particular, at least 6, more preferably at least 12, 24 or 36 dosage units.

It has also already been stated above what is achieved by the dispenser bottle with the receiving vessels 1, 2 configured in accordance with the invention. With reference especially to FIGS. 6a and 6b, FIG. 8, FIGS. 11a and 11b, FIG. 12, it can be explained in this regard that the shape and the dimensions of the expulsion nozzles 6, 7 and the properties of the active substance fluids are adjusted relative to one another such that—with average pressure from the hand of a user and/or pressure caused by gravity—the fluid streams overlap at a certain distance. In particular, this means that, in the working example of a dispenser bottle shown, the fluid streams overlap at a distance of from about 50 mm to about 300 mm, preferably of about 100 mm to about 250 mm, in particular, of about 150 mm. This is then about twice the distance between the expulsion nozzles 6, 7 and the application field. This corresponds to distances customary in the measures as are to be observed in the household in the case of cleaning measures, for example, in the case of cleaning of carpets.

With regard to the viscosity of the active substance fluids, it is advisable to use active substance fluids having viscosities in the range from 1 to 100,000 mPas, preferably up to about 10,000 mPas, in particular, up to about 1,000 mPas. The basis of these data is the viscosity measured with a Brookfield viscometer LVT-II at 20 rpm and 20° C., spindle no. 3.

FIGS. 3 and 4 show the receiving vessels 1, 2 with the outlets 3, 4. In this case, the outlets 3, 4 are aligned parallel to one another. A prealignment of the streams of the active substance fluids can also be achieved by aligning the outlets 3, 4 of the receiving vessels 1, 2 so as to be somewhat inclined toward one another. As a result of the production, the parallel alignment shown, however, has advantages.

In principle, it is possible, but not with the blow-molding process realized specifically here, to shape the expulsion nozzle 6; 7 integrally at the outlet 3; 4 on the receiving vessel 1; 2. However, this variant has not been selected in the working example shown. Instead, in the working example shown, it is envisaged that the expulsion nozzle 6; 7 be arranged or shaped in a separate nozzle head 12 consisting here of a dimensionally stable plastic, and that the nozzle head 12 be attached to the receiving vessel 1; 2 at the outlet 3; 4. In the figures, the nozzle head 12 is identified in each case with reference numeral 12. In the working example shown, the nozzle head 12 is snap-fitted to the receiving vessel 1; 2. The nozzle head 12 may also be joined to the receiving vessel 1; 2 in another way. However, snap-fitting is found to be a particularly simple and appropriate production technique.

To snap-fit the nozzle head 12 to the particular receiving vessel 1; 2, it is advisable to provide corresponding snap-fit connection means at the outlet 3; 4 of the receiving vessel 1; 2 for snap-fitting connection means of the nozzle head 12 which fit them. Such snap-fitting connection means are known from the prior art for corresponding constructions. In principle, it is also possible to use other connecting techniques, for example, screw connections.

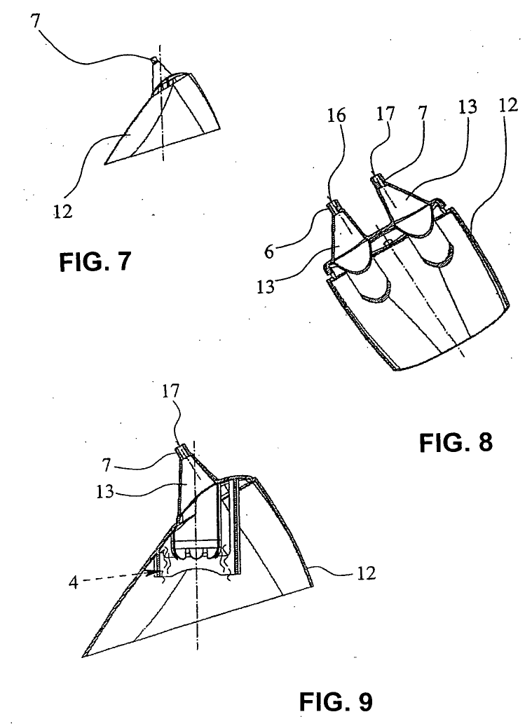

The preferred working examples shown have the particular feature that the nozzle heads 12 of the two receiving vessels 1; 2 are combined in a common nozzle head 12. This common nozzle head 12 can be seen in FIGS. 7, 8, 9, 10 and 12, 14. This is very practical from a production point of view and extremely well matched to the connection of the two receiving vessels 1, 2.

It is advisable to produce the nozzle head 12 from a relatively stiff plastics material, so that the nozzle head 12 experiences only slight deformation when the receiving vessels 1, 2 of the dispenser bottle are compressed.

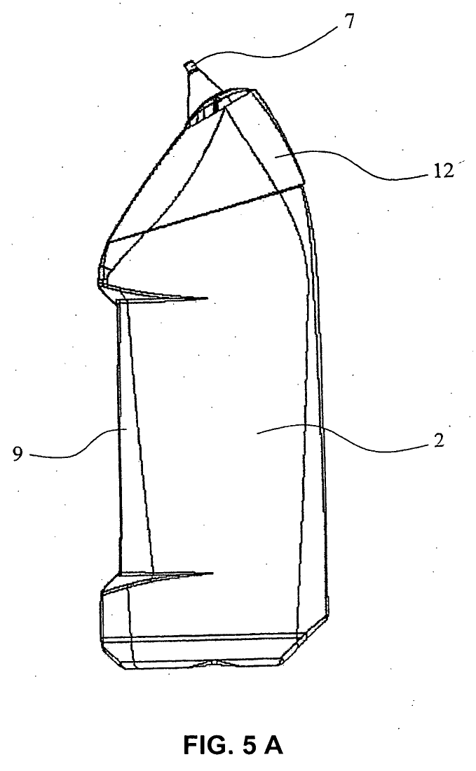

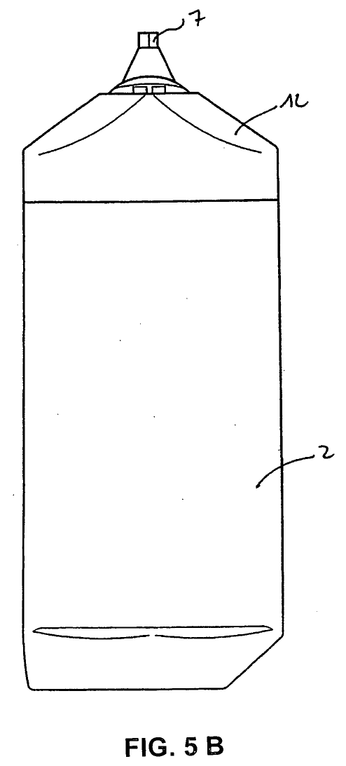

There is a series of possible configurations for the nozzle head 12, which are to be explained below. The nozzle head 12 can be seen in the figures shown below and in FIG. 5 and FIG. 6. The nozzle head 12 can be seen particularly clearly in section in FIGS. 8, 9, 10. It is found that it is appropriate for the flow of the active substance fluid in the nozzle head 12 that the expulsion nozzle 6; 7 is arranged asymmetrically in the nozzle head 12, especially offset in the direction of the further expulsion nozzles 7; 6, with respect to the center line of the outlet 3; 4. This can be seen particularly clearly in FIG. 8. The flow of the active substance fluid out of the particular receiving vessel 1; 2 is continued up to the desired distance from the active substance fluid flowing out in parallel.

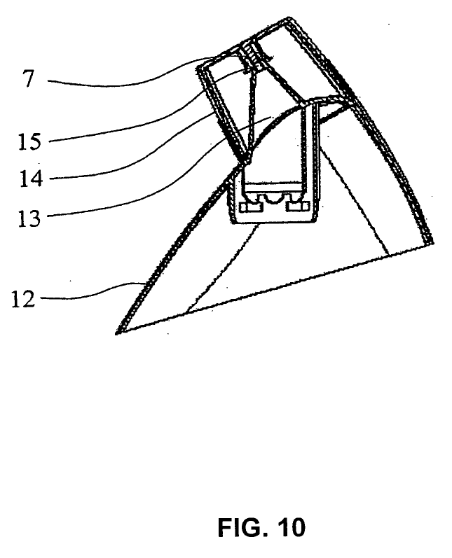

A constructive solution which ensures laminar flow can be recognized here. Specifically, it is envisaged that the nozzle head 12 has an inflow volume 13 narrowing from the outlet 3; 4 of the receiving vessel 1; 2 toward the expulsion nozzle 6; 7. This inflow volume 13 can be appreciated particularly clearly in FIG. 8 and FIG. 9.

The preferred working example shown shows a design to the effect that the lateral midpoint separation of the expulsion nozzles 6; 7 externally is from about 5 mm to about 30 mm, preferably from about 15 mm to about 20 mm.

It can be seen from figs 1a, 1b and 2a, 2b and from FIG. 10 that it is also envisaged for the dispenser bottles shown here that the expulsion nozzle 6; 7 can be closed with a removable closure cap 14 which preferably consists of a dimensionally stable polymer. It is envisaged that the closure cap 14 has a closure stopper 15 which enters into the expulsion nozzle 6; 7. This technique is already well-established for the prevention of cross-contaminations (see above, WO 91/04923 A1). In another embodiment, as shown in FIGS. 14 and 15, the closure cap 14 has laterally, in addition to the closure stopper 15 entering into the expulsion nozzle 6; 7, in each case a cylinder section 19 bent convex to the longitudinal axis of the closure cap 14 as a positioning aid. This cylinder section 19 is spaced apart from the closure stopper 15 such that the free ends of the cylinder section 19 adjoin the expulsion nozzles 6, 7 in closure position. When the closure cap 14 is attached to the dispenser bottle, the lower ends of the cylinder sections 19 slide along the oblique surfaces of the expulsion nozzles 6, 7; the motion is thus forced. The attachment operation of the closure cap 14 with the cylinder sections 19 as positioning aids and the closure stopper 15 onto the expulsion nozzles 6, 7 is shown schematically in FIG. 14.

The preferred working examples show, particularly clearly in figs 1a, 1b and 14, that, it is also the case for the closure cap 14 that it is combined together for the two expulsion nozzles 6, 7 of the two receiving vessels 1, 2. This is appropriate from a production point of view, just like that which has already been explained as appropriate for the nozzle head 12. Appropriately, the closure cap 14 consists of a similar plastics material or the same plastics material as the nozzle head 12.

It can be taken from the drawings that the expulsion nozzles 6, 7, of course, have a nozzle channel 16 or 17. It would be possible to envisage that the nozzle channels 16, 17 of the expulsion nozzles 6, 7 are inclined toward one another. In that case, the exiting streams of the active substance fluids would already have alignment to a common application field 5. However, the working example shown, which is preferred in this regard, shows that the nozzle channels 16, 17 of the expulsion nozzles 6, 7 are aligned parallel to one another. A slight deviation, in the context, for example, of the manufacturing tolerances, is of course acceptable.

Especially in the case of the working example shown in the drawing and explained above, with the nozzle channels 16, 17 aligned essentially in parallel to one another, it is particularly appropriate when the nozzle channels 16; 17 of the expulsion nozzles 6; 7 each have a cross-sectional constriction 18 arranged asymmetrically to the overall flow cross-section.

In the general part of the description, the particular significance of the cross-sectional constriction 18 in the particular nozzle channel 16 or 17 has already been pointed out. This can be appreciated with reference to FIGS. 11a and 11b.

The cross-sectional constriction 18 in the particular nozzle channel 16, 17 leads to a certain swirl being imparted to the streams of the active substance fluids, so that there is a certain deflection in each case in the exit region of the expulsion nozzles 6, 7, so that the streams of the active substance fluids then meet with mixing in the application field at a distance which depends in a certain manner upon the pressure of the hand of the user on the receiving vessels 1, 2.

Combination of the streams of the active substance fluids is thus achieved not by alignment of the nozzle channels 16, 17 but rather by influencing the flow. Moreover, full coincidence of the streams of the active substance fluids in the application field 5 is achieved, and not just by partial coincidence achieved by scattering action, as might occur in the case of unmodified nozzle channels 16, 17.

The particularly preferred embodiment of the invention explained above now requires further illustrations.

FIGS. 11a, 11b shows the principle by which the cross-sectional constrictions 18 function at the top, and an example of the arrangement of the cross-sectional constrictions 18 in the mutually adjacent nozzle channels 16, 17 at the bottom. It can be seen here first that, in the working example shown and preferred in this regard, the cross-sectional constrictions 18 of the nozzle channels 16, 17 are designed with angular transitions. In terms of flow, this has the consequence that different flow rates occur over the flow cross-section of the nozzle channel 16; 17. Far away from the cross-sectional constriction 18, the active substance fluid can flow comparatively undisturbed; it retains a high flow rate with laminar flow. At the cross-sectional constriction 18, in contrast, although a significantly higher flow rate arises in the narrowest cross-section, a large lowering in the flow rate associated with the formation of turbulences arises on leaving the constriction. The overall effect leads to the swirl-like behavior of the streams of the active substance fluids addressed above.

It can also be seen in FIGS. 11a, 11b that the cross-sectional constrictions 18 are arranged on the sides of the nozzle channels 16; 17 facing one another, in such a way that the streams of the active substance fluids exiting under pressure have such a swirl that they run toward one another.

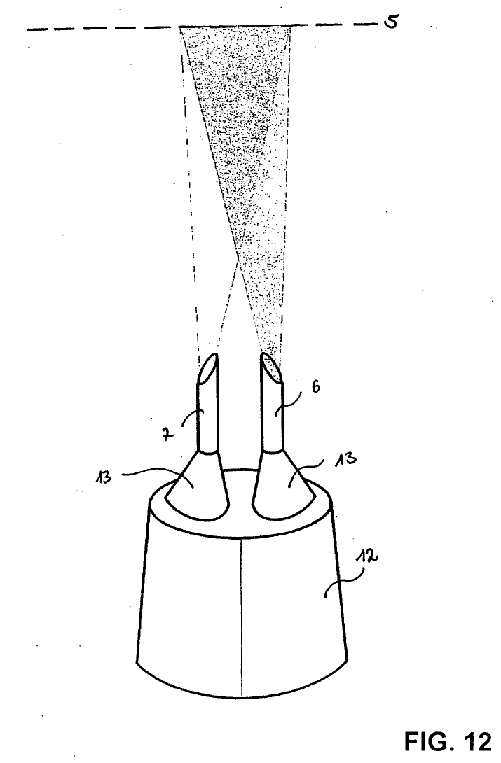

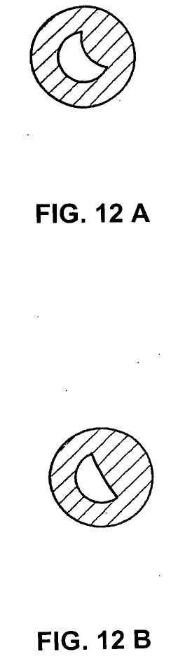

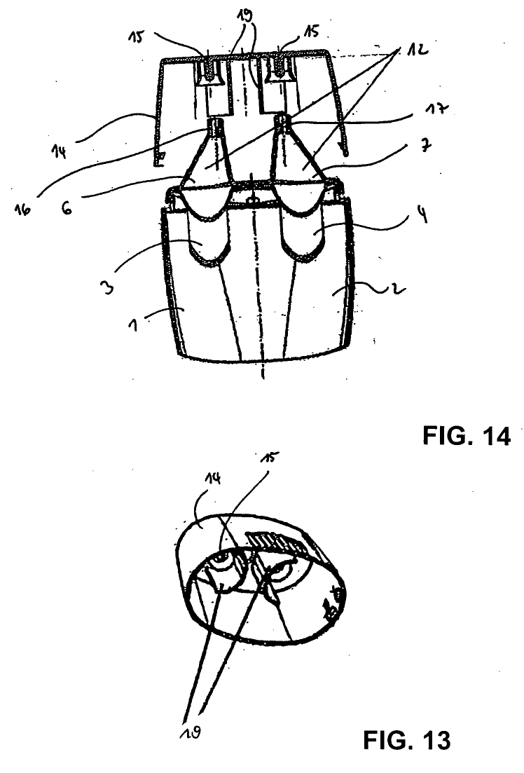

In contrast to the working example from FIG. 11a, the working example according to FIG. 11b has an oblique orifice plane of the nozzle channels 16, 17; see also nozzle head 12 according to FIG. 12. This canting of the ends of the nozzle channels likewise generates the swirl effect owing to different flow rates in the outlet. The swirl effect is caused by the orifices of the nozzle channels of the expulsion nozzles being canted with respect to one another. The orifice planes of the nozzle channels 6, 7 are arranged angled with respect to one another, the inner section of the wall of the expulsion nozzle with respect to the longitudinal axis of the nozzle channel being longer than the outer section of the wall with respect to the longitudinal axis of the nozzle channel. In a working example which is not shown, the swirl effect is generated by the provision only of oblique orifices at the end of the nozzle channel, but not of a cross-sectional constriction in the nozzle channel.

In the working examples shown in FIGS. 11a, 11b, the particular cross-sectional constriction 18 is designed as a concave arc. FIGS. 12a and 12b show further appropriate cross-sectional embodiments. Here, different cross-sectional shapes will possibly also be selected for the cross-sectional constrictions 18, just like for the nozzle channels 16, 17, with the different active substance fluids.

For the action of the cross-sectional constriction 18, it has been found to be advantageous when it does not occur over the full length of the nozzle channel 16; 17 but rather is restricted to a short part of this length. It is thus advisable that the length of the cross-sectional constriction 18 of the nozzle channels 16; 17 is only part of the length of the nozzle channel 16; 17 as a whole. In particular, it is advisable that the length ratio is from about 1:2 to 1:4, preferably from about 1:2.5 to 1:3.

For the application sector in the household particularly contemplated here and the use of mobile, preferably thixotropic, active substance fluids, it is advisable that the total length of the nozzle channel 16; 17 is from about 2 mm to about 6 mm, preferably from about 3 mm to about 5 mm, in particular, about 4 mm. Correspondingly, the diameter of the nozzle channel 16; 17 is from about 1.0 mm to about 4.0 mm, preferably from about 1.5 mm to about 3.5 mm, in particular, from about 2.0 mm to about 2.5 mm.

In a further embodiment, it is preferred that the cross-sectional constrictions 18 are designed with angular transitions on the sides of the nozzle channels 16; 17 facing one another and that the cross-sectional constrictions 18 are canted on the sides of the nozzle channels 16; 17 facing away from one another starting from the inflow side directed toward the middle of the nozzle channels 16; 17, i.e. are chamfered on the inflow side. This chamfer in the particular nozzle channel 16; 17 can extend over about half of the cross-sectional constriction 18, preferably exactly symmetrically. In principle, the present teaching also applies in a corresponding manner when the nozzle channels 16; 17 of the expulsion nozzles 6; 7 are aligned so as to be inclined toward one another. However, a particularly simple design is that addressed here with essentially parallel alignment of the nozzle channels 16; 17. A preferred embodiment envisages that the chamfers have a chamfer angle relative to the center axes of the nozzle channels 16; 17 of from 5° to 85°, preferably from 10° to 60°, in particular, from 35° to 40°. The cross-sectional constrictions 18 as a whole are, with the exception of the chamfers, preferably arranged symmetrically relative to the overall flow cross-section of the nozzle channels 16; 17. This can be realized by virtue of the cross-sectional constrictions 18 as a whole, with the exception of the chamfers, being formed in a circular shape in circular nozzle channels 16; 17. The combination of the differently contoured regions of the cross-sectional constriction 18 in the particular nozzle channel 16; 17 leads to an even more highly optimized and readily calculable flow image of the fluids.

If this has essentially fully described the constructive configuration of the inventive dispenser bottle, there will now be further details of what types of washing compositions consisting of a plurality of part-compositions are applied with such a dispenser bottle in a particularly appropriate manner.

It is possible in principle to use, as the different active substance fluids for the different receiving vessels (1, 2), those active substance fluids as are known for two-phase or multiphase liquid compositions, although, deviating from the two-phase or multiphase compositions known per se, the different phases of these compositions are formulated in the different receiving vessels (1, 2).

It is essential to the invention that the first part-composition comprises water, hydrogen peroxide and surfactant, and has an acidic pH. This means that it has, in undiluted form, a pH below 7, preferably in the range from 3.5 to below 7, in particular, from 4 to 6.5 and more preferably from 5.0 to 6.0. A pH in this range can be established by the presence of system-compatible acids, for example, mineral acids such as hydrochloric acid, sulfuric acid and/or phosphoric acid, amidosulfonic acid, and/or organic acids such as formic acid and/or citric acid, but also by the—optionally additional—presence of chelating agents specified below in their acid form. The acidic pH contributes to the prolonged storage stability of the hydrogen peroxide present in the first part-composition. The fraction of hydrogen peroxide in the first part-composition is preferably from 1.5% by weight to 15% by weight, in particular, from 2.5% by weight to 10% by weight and more preferably from 5% by weight to 8% by weight.

The second part-composition has an alkaline pH (i.e. above pH 7) of preferably in the range from 9 to 13.5, and is preferably likewise aqueous, in which case its water content may be up to 99.95% by weight and is preferably in the range from 50% by weight to 98% by weight, in particular, from 60% by weight to 95% by weight. If it is anhydrous, which is understood here to mean the presence of such small amounts of water that they do not enable the direct measurement of the pH, the feature of its alkaline pH is based on the fact that it contains a sufficient amount of substances alkaline in water that, after mixing with the first part-composition in a volume ratio of 1:1, the resulting pH is at least 1 unit, preferably at least 1.5 units, above that of the first part-composition. The pH which arises on mixing of the two part-compositions in a volume ratio of 1:1 is preferably in the range from 8.5 to 11.

The alkaline pH of the second part-composition is preferably brought about by the presence of organic bases such as amines, in particular, mono-, di- and/or trialkyl- and/or alkanolamines, preferably ethanolamines, or inorganic bases such as alkali metal hydroxide, alkali metal carbonate or mixtures thereof, sodium and/or potassium being the preferred alkali metal. Amounts of up to 5% by weight of such alkalizing agents are normally entirely sufficient in the second part-composition to establish a pH of preferably from 11 to 13 for this part-composition. When, in the case of combination of the acidic first part-composition with an alkaline second part-composition, the alkaline part-composition contains carbonate, the mixing of these two part-compositions (when the composition is used) releases carbon dioxide, which leads to the foaming of the composition and promotes its cleaning performance, especially in the case of direct application to a soiled textile, for example, to an item of clothing in a pretreatment step before textile washing, or a carpet or a cushion.

An inventive composition may also comprise fragrances, but it should be noted that some fragrances are not very stable in the acidic pH range and/or in the presence of bleaches. In contrast, the stability of high-value fragrances can be realized optimally in an alkaline medium, so that any fragrance content of the composition can be restricted if appropriate to the alkaline second part-composition.

Apart from water, the liquid part-compositions may also comprise nonaqueous solvents which stem, for example, from the group of the monoalcohols, diols, triols and polyols, of the ethers, esters and/or amides. Particular preference is given to nonaqueous solvents which are entirely miscible with water at room temperature, i.e. are miscible without a miscibility gap.

Nonaqueous solvents which can be used in the inventive dispenser bottles stem preferably from the group of the mono- or polyhydric alcohols, alkanolamines or glycol ethers, provided that they are miscible with water in the concentration range specified. The solvents are preferably selected from ethanol, n-propanol or isopropanol, butanols, glycol, propane- or butanediol, glycerol, diglycol, propyl- or butyldiglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol methyl or ethyl ether, methoxy-, ethoxy- or butoxytriglycol, 1-butoxyethoxy-2-propanol, 3-methyl-3-methoxybutanol, propylene glycol t-butyl ether and mixtures of these solvents.

In addition to the liquids, free-flowing solids, for example, powders, granules or microcompactates, are also considered to be free-flowing substances/substance mixtures in the context of the present application. The solids mentioned may be present in amorphous and/or crystalline and/or semicrystalline form. The particle size of these free-flowing solids is preferably in the range from 10 to 2,000 μm, more preferably in the range from 20 to 1,000 μm and in particular, in the range from 50 to 500 μm. Particular preference is given to free-flowing solids in which at least 70% by weight of the particles, preferably at least 90% by weight of the particles, have a particle size below 1,000 μm, preferably below 800 μm, more preferably below 400 μm.

The surfactants present in the first part-composition and optionally the second part-compositions include in particular, anionic surfactants and nonionic surfactants, although cationic surfactants and amphoteric surfactants may also be useful.

The anionic surfactants used are preferably one or more substances from the group of the carboxylic acids, the sulfuric monoesters and the sulfonic acids, preferably from the group of the fatty acids, the fatty alkylsulfuric acids and the alkylarylsulfonic acids. In order to have sufficient surface-active properties, the compounds mentioned should have relatively long-chain hydrocarbon radicals, i.e. have at least 6 carbon atoms in the alkyl or alkenyl radical. Typically, the carbon chain distributions of the anionic surfactants are in the range from 6 to 40, preferably from 8 to 30 and in particular, from 12 to 22 carbon atoms.

Carboxylic acids which find use as soaps in detergents in the form of their alkali metal salts are obtained industrially for the most part from native fats and oils by hydrolysis. While the alkaline hydrolysis which was carried out even in the nineteenth century led directly to the alkali metal salts (soaps), the practice today is to use only water for hydrolysis on the industrial scale, which hydrolyzes the fats into glycerol and the free fatty acids. Processes employed on the industrial scale are, for example, hydrolysis in an autoclave or continuous high-pressure hydrolysis. In the context of the present invention, carboxylic acids which can be used in acid form as anionic surfactants are, for example, hexanoic acid (caproic acid), heptanoic acid (enanthic acid), octanoic acid (caprylic acid), nonanoic acid (pelargonic acid), decanoic acid (capric acid), undecanoic acid, etc. Preference is given in the context of the present invention to the use of fatty acids such as dodecanoic acid (lauric acid), tetradecanoic acid (myristic acid), hexadecanoic acid (palmitic acid), octadecanoic acid (stearic acid), eicosanoic acid (arachic acid), docosanoic acid (behenic acid), tetracosanoic acid (lignoceric acid), hexacosanoic acid (cerotic acid), triacotanoic acid (melissic acid), and also the unsaturated species 9c-hexadecenoic acid (palmitoleic acid), 6c-octadecenoic acid (petroselic acid), 6t-octadecenoic acid (petroselaidic acid), 9c-octadecenoic acid (oleic acid), 9t-octadecenoic acid (elaidic acid), 9c, 12c-octadecadienoic acid (linoleic acid), 9t, 12t-octadecadienoic acid (linolaidic acid) and 9c, 12c, 15c-octadecatrienoic acid (linolenic acid). For reasons of cost, preference is given not to using the pure species, but rather technical mixtures of the individual acids, as obtainable from fat hydrolysis. Such mixtures are, for example, coconut oil fatty acid (approx. 6% by weight of C8, 6% by weight of C10, 48% by weight of C12, 18% by weight of C14, 10% by weight of C16, 2% by weight of C18, 8% by weight of C18′, 1% by weight of C18′), palm kernel oil fatty acid (approx. 4% by weight of C8, 5% by weight of C10, 50% by weight of C12, 15% by weight of C14, 7% by weight of C16, 2% by weight of C18, 15% by weight of C18′, 1% by weight of C18″), tallow fatty acid (approx. 3% by weight of C14, 26% by weight of C16, 2% by weight of C 16′, 2% by weight of C17, 17% by weight of C18, 44% by weight of C18′, 3% by weight of C18″, 1% by weight of C18′″), hardened tallow fatty acid (approx. 2% by weight of C14, 28% by weight of C16, 2% by weight of C17, 63% by weight of C18, 1% by weight of C18′), technical oleic acid (approx. 1% by weight of C12, 3% by weight of C14, 5% by weight of C16, 6% by weight of C16′, 1% by weight of C17, 2% by weight of C18, 70% by weight of C18′, 10% by weight of C18″, 0.5% by weight of C18′″), technical palmitic/stearic acid (approx. 1% by weight of C12, 2% by weight of C14, 45% by weight of C16, 2% by weight of C17, 47% by weight of C18, 1% by weight of C18′) and soybean oil fatty acid (approx. 2% by weight of C14, 15% by weight of C16, 5% by weight of C18, 25% by weight of C18′, 45% by weight of C18″, 7% by weight of C18′″).

Sulfuric monoesters of relatively long-chain alcohols are likewise anionic surfactants and can be used in the context of the present invention. Their alkali metal salts, especially sodium salts, the fatty alcohol sulfates, are obtainable on the industrial scale from fatty alcohols which are reacted with sulfuric acid, chlorosulfonic acid, amidosulfonic acid or sulfur trioxide to give the alkylsulfuric acids in question and subsequently neutralized. The fatty alcohols are obtained from the fatty acids or fatty acid mixtures in question by high-pressure hydrogenation of the fatty acid methyl esters. The quantitatively most significant industrial process for the preparation of fatty alkyl sulfuric acids is the sulfonation of the alcohols with SO₃/air mixtures in special battery, falling-film or tube bundle reactors.

A further class of anionic surfactants which can be used in accordance with the invention is that of the alkyl ether sulfuric acids whose salts, the alkyl ether sulfates, feature higher water solubility and lower sensitivity toward water hardness (solubility of the calcium salts) in comparison to the alkyl sulfates. Like the alkyl sulfuric acids, alkyl ether sulfuric acids are synthesized from fatty alcohols which are reacted with ethylene oxide to give the fatty alcohol ethoxylates in question. Instead of ethylene oxide, it is also possible to use propylene oxide. The subsequent sulfonation with gaseous sulfur trioxide in short-path sulfonation reactors affords yields of above 98% of the alkyl ether sulfuric acids in question, which are typically used in the form of alkali metal salts, especially sodium salts, after they have been neutralized.

In the context of the present invention, it is also possible to use alkanesulfonic acids and olefinsulfonic acids as anionic surfactants, if appropriate in their acid form. Alkanesulfonic acids may contain the sulfonic acid group in terminally bonded form (primary alkanesulfonic acids) or along the carbon chain (secondary alkanesulfonic acids), but only the secondary alkanesulfonic acids are of commercial significance. They are prepared by sulfochlorination or sulfoxidation of linear hydrocarbons. In the Reed sulfochlorination, n-paraffins are reacted with sulfur dioxide and chlorine with irradiation with UV light to give the corresponding sulfochlorides which on hydrolysis with alkalis directly afford the alkanesulfonates, on reaction with water the alkanesulfonic acids. Since di- and polysulfochlorides and also chlorinated hydrocarbons can occur as by-products of the free-radical reaction in the course of the sulfochlorination, the reaction is typically carried out only up to degrees of conversion of 30% and then terminated.

Another process for the preparation of alkanesulfonic acids is sulfoxidation, in which n-paraffins are reacted with sulfur dioxide and oxygen under irradiation with UV light. In this free-radical reaction, alkylsulfonyl radicals are formed gradually and react further with oxygen to give the alkylpersulfonyl radicals. The reaction with unconverted paraffin affords an alkyl radical and the alkylpersulfonic acid which decomposes into an alkylperoxysulfonyl radical and a hydroxyl radical. The reaction of the two radicals with unconverted paraffin affords the alkylsulfonic acids or water which reacts with alkylpersulfonic acid and sulfur dioxide to give sulfuric acid. In order to keep the yield of the two end products, alkylsulfonic acid and sulfuric acid, very high and to suppress side reactions, this reaction is typically only carried out up to degrees of conversion of 1% and then terminated.

Olefinsulfonates are prepared industrially by the reaction of α-olefins with sulfur trioxide. This forms zwitterions as an intermediate, which cyclize to give sultones. Under suitable conditions (alkaline or acidic hydrolysis), these sultones react to give hydroxyalkanesulfonic acids or alkenesulfonic acids, both of which may likewise be used as anionic surfactant acids.

Alkylbenzenesulfonates as high-performance anionic surfactants have been known since the 1930s. At that time, monochlorination of “kogasin” fractions and subsequent Friedel-Crafts alkylation were used to prepare alkylbenzenes which were sulfonated with oleum and neutralized with sodium hydroxide solution. At the start of the 1950s, alkylbenzenesulfonates were prepared by tetramerizing propylene to give branched α-dodecylene, and the product was converted by a Friedel-Crafts reaction using aluminum trichloride or hydrogen fluoride to tetrapropylenebenzene which was subsequently sulfonated and neutralized. This economic means of preparing tetrapropylenebenzenesulfonates (TPS) led to the breakthrough for this class of surfactant, which subsequently replaced soaps as the main surfactant in detergents.

Owing to the inadequate biodegradability of TPS, there is a need to provide novel alkylbenzenesulfonates which are characterized by improved ecological performance. These requirements are satisfied by linear alkylbenzenesulfonates, which are nowadays almost the only alkylbenzenesulfonates prepared and are denoted by the abbreviation ABS or LAS.

Linear alkylbenzenesulfonates are prepared from linear alkylbenzenes which in turn are obtainable from linear olefins. For this purpose, petroleum fractions are separated on the industrial scale into the n-paraffins of the desired purity using molecular sieves and dehydrogenated to give the n-olefins, resulting in both α- and isoolefins. The resulting olefins are then reacted in the presence of acidic catalysts with benzene to give the alkylbenzenes, the selection of the Friedel-Crafts catalyst having an influence on the isomer distribution of the resulting linear alkylbenzenes: when aluminum trichloride is used, the content of the 2-phenyl isomers in the mixture with the 3-, 4-, 5- and other isomers is approx. 30% by weight; if, on the other hand, the catalyst used is hydrogen fluoride, the content of 2-phenyl isomer can be lowered to approx. 20% by weight. Finally, the linear alkylbenzenes are nowadays sulfonated on the industrial scale with oleum, sulfuric acid or gaseous sulfur trioxide, of which the latter is by far the most significant. For the sulfonation, special film or tube-bundle reactors are used and afford, as the product, 97% by weight alkylbenzenesulfonic acid (ABSA).

The selection of the neutralizing agent makes it possible to obtain a very wide variety of salts, i.e. alkylbenzenesulfonates, from the ABSAs. For economic reasons, preference is given to preparing and using the alkali metal salts and, among these, preferably the sodium salts of ABSA. These can be described by the following general formula: 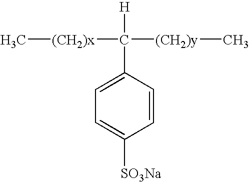
in which the sum of x and y is typically between 5 and 13. Anionic surfactants in acid form preferred in accordance with the invention are C8-16-alkylbenzenesulfonic acids, preferably C9-13-alkylbenzenesulfonic acids. In the context of the present invention, preference is also given to using C8-16-alkylbenzenesulfonic acids, preferably C9-13-alkylbenzenesulfonic acids which derive from alkylbenzenes which have a tetralin content below 5% by weight, based on the alkylbenzene. Preference is further given to using alkylbenzenesulfonic acids whose alkylbenzenes have been prepared by the HF process, so that the C8-16-alkylbenzenesulfonic acids, preferably C9-13-alkylbenzenesulfonic acids used have a content of 2-phenyl isomer below 22% by weight, based on the alkylbenzenesulfonic acid.

The anionic surfactants mentioned may be used alone or together in a mixture, particular preference being given to ether sulfates and mixtures of fatty acids and ether sulfates, especially in weight ratios of from 5:1 to 1:5, preferably from 2:1 to 1:2. The anionic surfactants described above in their acid form are typically used in partly or fully neutralized form. Possible cations for the anionic surfactants are, in addition to the alkali metals (here in particular, sodium and potassium salts), ammonium and mono-, di- or triethanolammonium ions. Instead of mono-, di- or triethanolamine, the analogous representatives of mono-, di- or trimethanolamine or those of the alkanolamines of higher alcohols may also be quaternized and be present as the cation.

The nonionic surfactants used are preferably alkoxylated, advantageously ethoxylated, in particular, primary alcohols having preferably from 8 to 18 carbon atoms and on average from 1 to 12 mol of ethylene oxide (EO) per mole of alcohol in which the alcohol radical may be linear or preferably 2-methyl-branched, or may contain a mixture of linear and methyl-branched radicals, as are typically present in oxo alcohol radicals. However, especially preferred alcohol ethoxylates have linear radicals of alcohols of natural origin having from 12 to 18 carbon atoms, for example, of coconut, palm, tallow fat or oleyl alcohol, and on average from 2 to 8 EO per mole of alcohol. The preferred ethoxylated alcohols include, for example, C12-14-alcohols having 3 EO or 4 EO, C9-11-alcohol having 7 EO, C13-15-alcohols having 3 EO, 5 EO, 7 EO or 8 EO, C12-18-alcohols having 3 EO, 5 EO or 7 EO and mixtures thereof, such as mixtures of C12-14-alcohol having 3 EO and C12-18-alcohol having 5 EO. The degrees of ethoxylation specified are statistical average values which may be an integer or a fraction for a specific product. Preferred alcohol ethoxylates have a narrowed homolog distribution (narrow range ethoxylates, NRE). In addition to these nonionic surfactants, it is also possible to use fatty alcohols having more than 12 EO. Examples thereof are tallow fatty alcohol having 14 EO, 25 EO, 30 EO or 40 EO. It is also possible to use low-foaming nonionic surfactants which have alternating ethylene oxide and alkylene oxide units. Among these, preference is given in turn to surfactants having EO-AO-EO-AO blocks, in which from one to ten EO or AO groups in each case are bonded to one another before being followed by a block of the other groups in each case. Examples thereof are surfactants of the general formula 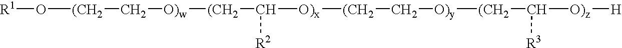
in which R¹ is a straight-chain or branched, saturated or mono- or polyunsaturated C₆₋₂₄-alkyl or -alkenyl radical; each R² or R³ group is independently selected from —CH₃; —CH₂CH₃, —CH₂CH₂—CH₃, —CH(CH₃)₂ and the indices w, x, y, z are each independently integers from 1 to 6. These can be prepared by known methods from the corresponding alcohols R¹-OH and ethylene oxide or alkylene oxide. The R¹ radical in the above formula may vary depending on the origin of the alcohol. When native sources are utilized, the R¹ radical has an even number of carbon atoms and is generally unbranched, and preference is given to the linear radicals of alcohols of native origin having from 12 to 18 carbon atoms, for example, from coconut, palm, tallow fat or oleyl alcohol. Alcohols obtainable from synthetic sources are, for example, the Guerbet alcohols or 2-methyl-branched or linear and methyl-branched radicals in a mixture, as are typically present in oxo alcohol radicals. Irrespective of the type of the alcohol used to prepare the nonionic surfactants present in accordance with the invention in the products, preference is given to inventive compositions in which R¹ in the above formula is an alkyl radical having from 6 to 24, preferably from 8 to 20, more preferably 9 to 15 and in particular, 9 to 11 carbon atoms. The alkylene oxide unit which may be present in the preferred nonionic surfactants in alternation to the ethylene oxide unit is, as well as propylene oxide, especially butylene oxide. However, further alkylene oxides in which R² and R³ are each independently selected from —CH₂CH₂—CH₃ and —CH(CH₃)₂ are also suitable.

In addition, the nonionic surfactants used may also be alkyl glycosides of the general formula RO(G)x in which R is a primary straight-chain or methyl-branched, in particular, 2-methyl-branched, aliphatic radical having from 8 to 22, preferably from 12 to 18, carbon atoms and G is the symbol which is a glycose unit having 5 or 6 carbon atoms, preferably glucose. The degree of oligomerization x, which specifies the distribution of monoglycosides and oligoglycosides, is any number between 1 and 10; x is preferably from 1.2 to 1.4.

A further class of nonionic surfactants used with preference, which are used either as the sole nonionic surfactant or in combination with other nonionic surfactants, are alkoxylated, preferably ethoxylated or ethoxylated and propoxylated, fatty acid alkyl esters, preferably having from 1 to 4 carbon atoms in the alkyl chain, in particular, fatty acid methyl esters.

Nonionic surfactants of the amine oxide type, for example, N-cocoalkyl-N,N-dimethylamine oxide and N-tallow alkyl-N,N-dihydroxyethylamine oxide, and of the fatty acid alkanolamide type may also be suitable.

Further suitable surfactants are polyhydroxy fatty acid amides of the following formula 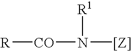
in which RCO is an aliphatic acyl radical having from 6 to 22 carbon atoms, R¹ is hydrogen, an alkyl or hydroxyalkyl radical having from 1 to 4 carbon atoms and [Z] is a linear or branched polyhydroxyalkyl radical having from 3 to 10 carbon atoms and from 3 to 10 hydroxyl groups. The polyhydroxy fatty acid amides are known substances which can typically be obtained by reductively aminating a reducing sugar with ammonia, an alkylamine or an alkanolamine, and subsequently acylating with a fatty acid, a fatty acid alkyl ester or a fatty acid chloride.

The group of polyhydroxy fatty acid amides also includes compounds of the formula 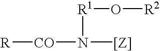
in which R is a linear or branched alkyl or alkenyl radical having from 7 to 12 carbon atoms, R¹ is a linear, branched or cyclic alkyl radical or an aryl radical having from 2 to 8 carbon atoms and R² is a linear, branched or cyclic alkyl radical or an aryl radical or an oxyalkyl radical having from 1 to 8 carbon atoms, preference being given to C₁₋₄-alkyl or phenyl radicals, and [Z] is a linear polyhydroxyalkyl radical whose alkyl chain is substituted by at least two hydroxyl groups, or alkoxylated, preferably ethoxylated or propoxylated, derivatives of this radical.

[Z] is preferably obtained by reductive amination of a reduced sugar, for example, glucose, fructose, maltose, lactose, galactose, mannose or xylose. The N-alkoxy- or N-aryloxy-substituted compounds can then be converted to the desired polyhydroxy fatty acid amides by reaction with fatty acid methyl esters in the presence of an alkoxide as catalyst.

Further nonionic surfactants which can be used with preference are the terminally capped poly(oxyalkylated) nonionic surfactants of the formula
R¹O[CH₂CH(R³)O]ₓ[CH₂]ₖCH(OH)[CH₂]ⱼOR²
in which R¹ and R² are linear or branched, saturated or unsaturated, aliphatic or aromatic hydrocarbon radicals having from 1 to 30 carbon atoms, R³ is H or a methyl, ethyl, n-propyl, isopropyl, n-butyl, 2-butyl or 2-methyl-2-butyl radical, x is a value between 1 and 30, k and j are values between 1 and 12, preferably between 1 and 5. When the value x is >2, each R³ in the above formula may be different. R¹ and R² are preferably linear or branched, saturated or unsaturated, aliphatic or aromatic hydrocarbon radicals having from 6 to 22 carbon atoms, particular preference being given to radicals having from 8 to 18 carbon atoms. For the R³ radical, particular preference is given to H, —CH₃ or —CH₂CH₃. Particularly preferred values for x are in the range from 1 to 20, in particular, from 6 to 15.

Among the nonionic surfactants, preference is given to alkoxylated fatty alcohols, if appropriate in exchange for or in a blend with terminally capped polyalkoxylated surfactants. In the latter, the weight ratio is preferably from 10:1 to 1:2, in particular, from 10:1 to 2:1.

It is particularly preferred when the weight ratio of anionic surfactant to nonionic surfactant is between 10:1 and 1:10, preferably between 7.5:1 and 1:5, and in particular, between 5:1 and 1:2. It is preferred when the first part-composition contains from 1% by weight to 20% by weight, in particular, from 1.5% by weight to 10% by weight, of surfactant. Nonionic surfactant, especially alkoxylated fatty alcohol, and/or anionic surfactant, especially a sulfation product of an alkoxylated fatty alcohol, are the preferred surfactants. The ratios specified are based on the individual part-compositions in one embodiment of the invention and on the entire inventive composition in a further embodiment.

The part-compositions may additionally comprise all ingredients customary in liquid washing compositions which do not interact adversely in an unacceptable manner with the obligatory ingredients. The part-compositions which preferably comprise one or more of the abovementioned nonaqueous solvents may comprise further active substances, preferably from the group of the polymers, builders, cobuilders or threshold substances, enzymes, electrolytes, fragrances, perfume carriers, dyes, hydrotropes, foam inhibitors, antiredeposition agents, active antimicrobial ingredients, germicides, fungicides, antioxidants and corrosion inhibitors. The first part-composition preferably comprises, in addition to the obligatory ingredients, chelating agent, water-miscible solvent, free-radical scavenger, dye and/or fragrance.

The inventive liquid washing composition preferably does not comprise any active substance typically referred to as a bleach activator, i.e. a compound which releases a peroxycarboxylic acid or peroxyimide acid under perhydrolysis conditions.

The enzymes which may be present in the part-compositions, especially in the second part-composition, include in particular, proteases, amylases, lipases, hemicellulases and/or cellulases. These enzymes are in principle of natural origin; starting from the natural molecules, improved variants are available for use in washing and cleaning compositions and are preferably used correspondingly. Inventive compositions comprise, in the second part-composition or the further part-compositions, enzymes preferably in total amounts of from 1×10⁻⁶ to 5 percent by weight, based on active protein. The protein concentration can be determined with the aid of known methods, for example, the BCA process (bicinchonic acid; 2,2′-biquinolyl-4,4′-dicarboxylic acid) or the biuret process (A. G. Gornall, C. S. Bardawill and M. M. David, J. Biol. Chem. 177 (1948), p. 751-766). The first part-composition is preferably free of enzymes. In a preferred embodiment of inventive compositions, the second part-composition comprises proteases, amylases and cellulases.

Among the proteases, preference is given to those of the subtilisin type. Examples thereof include the subtilisins BPN' and Carlsberg, protease PB92, the subtilisins 147 and 309, Bacillus lentus alkaline protease, subtilisin DY and the enzymes thermitase and proteinase K which can be classified to the subtilases but no longer to the subtilisins in the narrower sense, and the proteases TW3 and TW7. The subtilisin Carlsberg is available in a developed form under the trade name Alcalase® from Novozymes A/S, Bagsvaerd, Denmark. The subtilisins 147 and 309 are sold under the trade names Esperase® and Savinase® respectively by Novozymes. The variants listed under the name BLAP® are derived from the protease of Bacillus lentus DSM 5483 (known from the International Patent Application WO 91/02792), and are described in particular, in WO 92/21760, WO 95/23221 and in the applications DE 10121463 and DE 10153792. Further useful proteases from different Bacillus sp. and B. gibsonii are disclosed by the patent applications DE 10162727, DE 10163883, DE 10163884 and DE 10162728. Further examples of useful proteases are the enzymes available under the trade names Durazym®, Relase®, Everlase®, Nafizym®, Natalase®, Kannase® and Ovozymes® from Novozymes, those under the trade names Purafect®, Purafect®OxP and Properase® from Genencor, that under the trade name Protosol® from Advanced Biochemicals Ltd., Thane, India, that under the trade name Wuxi®from Wuxi Snyder Bioproducts Ltd., China, those under the trade names Proleather®and Protease P® from Amano Pharmaceuticals Ltd., Nagoya, Japan and that under the name Proteinase K-16 from Kao Corp., Tokyo, Japan.

Examples of amylases which can be used in accordance with the invention are the a-amylases from Bacillus licheniformis, from B. amyloliquefaciens or from B. stearothermophilus and developments thereof which have been improved for use in detergents. The B. licheniformis enzyme is available from Novozymes under the name Termamyl® and from Genencor under the name Purastar®ST. Development products of this a-amylase are obtainable from Novozymes under the trade names Duramyl® and Termamyl®ultra, from Genencor under the name Purastar®OxAm and from Daiwa Seiko Inc., Tokyo, Japan as Keistase®. The B. amyloliquefaciensa-amylase is sold by Novozymes under the name BAN®, and variants derived from the B. stearothermophilus a-amylase under the names BSG® and Novamyl®, likewise from Novozymes. Enzymes which should additionally be emphasized for this purpose are the a-amylase from Bacillus sp. A 7-7 (DSM 12368) which is disclosed in the application WO 02/10356, and the cyclodextrin glucanotransferase (CGTase) from B. agaradherens (DSM 9948) which is described in the application PCT/EP01/13278; and also those which belong to the sequence region of a-amylases which is defined in DE 10131441. It is equally possible to use fusion products of the molecules mentioned, for example, those from DE 10138753. Also suitable are the developments of a-amylase from Aspergillus niger and A. oryzae, which are available under the trade name Fungamyl® from Novozymes. Another commercial product is Amylase-LT®, for example.

Inventive compositions may comprise lipases and/or cutinases. Examples thereof include the lipases which were originally obtainable from Humicola lanuginosa (Thermomyces lanuginosus) or have been developed, in particular, those with the D96L amino acid substitution. They are sold, for example, under the trade names Lipolase®, Lipolase®Ultra, LipoPrime®, Lipozyme® and Lipex® from Novozymes. It is additionally possible, for example, to use the cutinases which have originally been isolated from Fusarium solani pisi and Humicola insolens. Lipases which are also useful can be obtained under the designations Lipase CE®, Lipase P®, Lipase B®, Lipase CES®, Lipase AKG®, Bacillis sp. Lipase®, Lipase AP®, Lipase M-AP® and Lipase AML® from Amano. Examples of lipases and cutinases from Genencor which can be used are those whose starting enzymes have originally been isolated from Pseudomonas mendocina and Fusarium solanii. Other important commercial products include the M1 Lipase® and Lipomax® preparations originally sold by Gist-Brocades and the enzymes sold under the names Lipase MY-30®, Lipase OF® and Lipase PL® by Meito Sangyo KK, Japan, and also the product Lumafast® from Genencor.

Inventive compositions may comprise cellulases, depending on the purpose as pure enzymes, as enzyme preparations or in the form of mixtures in which the individual components advantageously complement one another with respect to their different performance aspects. These performance aspects include in particular, contributions to the primary washing performance, to the secondary washing performance of the composition (antiredeposition action or graying inhibition) and finishing (fabric action), up to exerting a “stone-wash” effect. A useful fungal, endoglucanase(EG)-rich cellulase preparation and developments thereof are supplied under the trade name Celluzyme® from Novozymes. The products Endolase® and Carezyme®, likewise available from Novozymes, are based on the H. insolens DSM 1800 50 kD EG and 43 kD EG respectively. Further possible commercial products of this company are Cellusoft®and Renozyme®. Likewise useful are the cellulases disclosed in the application WO 97/14804; for example, the Melanocarpus 20 kD EG cellulase, which is available under the trade names Ecostone® and Biotouch® from AB Enzymes, Finland. Further commercial products from AB Enzymes are Econase® and Ecopulp®. Further suitable cellulases from Bacillus sp. CBS 670.93 and 669.93 are disclosed in WO 96/34092, and that from Bacillus sp. CBS 670.93 is available under the trade name Puradax® from Genencor. Other commercial products from Genencor are Genencor detergent cellulase L and IndiAge®Neutra.

Inventive compositions may comprise further enzymes which are combined under the term hemicellulases. These include, for example, mannanases, xanthane lyases, pectin lyases (=pectinases), pectin esterases, pectate lyases, xyloglucanases (=xylanases), pullulanases and β-glucanases. Suitable mannanases are available, for example, under the names Gamanase® and Pektinex AR® from Novozymes, under the name Rohapec® B1L from AB Enzymes and under the name Pyrolase® from Diversa Corp., San Diego, Calif., USA. A suitable β-glucanase from a B. alcalophilus is disclosed, for example, by the application WO 99/06573. The β-glucanase obtained from B. subtilis is available under the name Cereflo® from Novozymes.

The enzymes which may be used in inventive compositions either derive originally from microorganisms, for example, of the genera Bacillus, Streptomyces, Humicola, or Pseudomonas, and/or are produced in biotechnology processes known per se by suitable microorganisms, for instance by transgenic expression hosts of the genera Bacillus or filamentous fungi.

Any enzyme present in an inventive composition may be protected, particularly during storage, from damage, for example, inactivation, denaturation or decay, for instance by physical influences, oxidation or proteolytic cleavage. For this purpose, inventive compositions may comprise stabilizers. One group of enzyme stabilizers is that of reversible protease inhibitors. Frequently, benzamidine hydrochloride, borax, boric acids, boronic acids or salts or esters thereof are used, and of these in particular, derivatives having aromatic groups, for instance ortho-substituted phenylboronic acids according to International Patent Application WO 95/12655, meta-substituted phenylboronic acids according to International Patent Application WO 92/19707 or para-substituted phenylboronic acids according to U.S. Pat. No. 5,972,873, or the salts or esters thereof. For the same purpose, International Patent Application WO 98/13460 and European Patent Application EP 583 534 disclose peptide aldehydes, i.e. oligopeptides with reduced C-terminus. Peptidic protease inhibitors which should be mentioned include ovomucoid (according to International Patent Application WO 93/00418 and leupeptin; an additional option is the formation of fusion proteins of proteases and peptide inhibitors. Further enzyme stabilizers are amino alcohols such as mono-, di-, triethanol- and -propanolamine and mixtures thereof, aliphatic carboxylic acids up to C12, disclosed, for example, by European Patent Application EP 0 378 261 or International Patent Application WO 97/05227, such as succinic acid, other dicarboxylic acids or salts of the acids mentioned. German Patent Application DE 196 50 537 discloses terminally capped fatty acid amide alkoxylates for this purpose. Particular organic acids which are used as builders are capable, as disclosed in International Patent Application WO 97/18287, additionally of stabilizing an enzyme present. Lower aliphatic alcohols such as ethanol or propanol, but in particular, polyols, for example, glycerol, ethylene glycol, propylene glycol or sorbitol, are further useful enzyme stabilizers. According to European Patent Application EP 0 965 268, diglycerol phosphate also protects against denaturation by physical influences. Calcium salts are likewise frequently used, for example, calcium acetate or the calcium formate disclosed for this purpose in European Patent Application EP 0 028 865, as are magnesium salts, for example, according to European Patent Application EP 0 378 262. Reducing agents and antioxidants increase, as disclosed, inter alia, in European Patent Application EP 0 780 466, the stability of the enzymes against oxidative decay. Sulfur-containing reducing agents are disclosed, for example, by the patents EP 0 080 748 and EP 0 080 223. Other examples of these are sodium sulfite (according to European Patent Application EP 0 533 239) and reducing sugars (according to European Patent Application EP 0 656 058).

Preference is given to using combinations of stabilizers, for example, of polyols, boric acid and/or borax according to International Patent Application WO 96/31589, the combination of boric acid or borate, reducing salts and succinic acid or other dicarboxylic acids according to European Patent Application EP 0 126 505, or the combination of boric acid or borate with polyols or polyamino compounds and with reducing salts, as disclosed in European Patent Application EP 0 080 223. The action of peptide-aldehyde stabilizers is, according to International Patent Application WO 98/13462, enhanced by the combination with boric acid and/or boric acid derivatives and polyols, and, according to International Patent Application WO 98/13459, further boosted by the additional use of divalent cations, for example, calcium ions.

The part-compositions may additionally comprise all ingredients customary in liquid washing compositions which do not interact adversely in an unacceptable manner. These include, for example, builder materials, complexing agents for heavy metals, nonaqueous water-miscible solvents, thickeners, graying inhibitors, foam regulators, dye transfer inhibitors, active antimicrobial ingredients, optical brighteners, dyes and fragrances. If desired, such further ingredients may also be present in the first part-composition provided that they do not impair the storage stability of the peracid components unacceptably.

The builder materials which may be present in the inventive compositions are in particular, silicates, aluminum silicates (especially zeolites), carbonates, salts of organic di- and polycarboxylic acids and mixtures of these substances.

Suitable crystalline, sheet-type sodium silicates have the general formula NaMSiₓO₂ₓ₊₁·yH₂O where M is sodium or hydrogen, x is from 1.9 to 4, y is from 0 to 20, and preferred values for x are 2, 3 or 4. Such crystalline sheet silicates are described, for example, in European Patent Application EP 0 164 514. Preferred crystalline sheet silicates of the formula specified are those in which M is sodium and x assumes the values of 2 or 3. In particular, preference is given to both β- and also δ-sodium disilicates Na₂Si₂O₅·yH₂O, β- sodium disilicate being obtainable, for example, by the process which is described in International Patent Application WO 91/08171.

It is also possible to use amorphous sodium silicates having an Na₂O:SiO₂ modulus of from 1:2 to 1:3.3, preferably from 1:2 to 1:2.8 and in particular, from 1:2 to 1:2.6, which have retarded dissolution and secondary washing properties. The retardation of dissolution relative to conventional amorphous sodium silicates may have been brought about in a variety of ways, for example, by surface treatment, compounding, compacting or by overdrying. In the context of this invention, the term “amorphous” also includes “X-ray-amorphous”. This means that, in X-ray diffraction experiments, the silicates do not afford any sharp X-ray reflections typical of crystalline substances, but rather yield at best one or more maxima of the scattered X-radiation, which have a width of several degree units of the diffraction angle. However, it may quite possibly lead to even particularly good builder properties if the silicate particles in electron diffraction experiments yield vague or even sharp diffraction maxima. This is to be interpreted such that the products have microcrystalline regions with a size of from 10 to several hundred nm, preference being given to values up to a maximum of 50 nm and in particular, up to a maximum of 20 nm. Such X-ray-amorphous silicates which likewise have retarded dissolution compared with conventional waterglasses are described, for example, in German Patent Application DE 44 00 024. Special preference is given to compacted amorphous silicates, compounded amorphous silicates and overdried X-ray-amorphous silicates.

The finely crystalline, synthetic and bound water-containing zeolite which may be used is preferably zeolite A and/or P. The zeolite P is more preferably Zeolite MAP® (commercial product from Crosfield). Also suitable, however, are zeolite X, and mixtures of A, X and/or P. Commercially available and usable with preference in the context of the present invention is, for example, also a cocrystal of zeolite X and zeolite A (approx. 80% by weight of Zeolite X) which is sold by Condea Augusta S.p.A. under the brand name VEGOBOND AX® and can be described by the formula nNa₂O·(1-n)K₂·Al₂O₃·(2-2.5)SiO₂·(3.5-5.5)H₂O. The zeolite can be used as a spray-dried powder or else as an undried, stabilized suspension which is still moist before its preparation. In the case that the zeolite is used as suspension, it may contain small additions of nonionic surfactants as stabilizers, for example, from 1 to 3% by weight, based on zeolite, of ethoxylated C₁₂-C₁₈ fatty alcohols having from 2 to 5 ethylene oxide groups, C₁₂-C₁₄ fatty alcohols having from 4 to 5 ethylene oxide groups or ethoxylated isotridecanols. Suitable zeolites have a mean particle size of less than 10 μm (volume distribution; analysis method, for example, by means of Coulter Counter) and contain preferably from 18 to 22% by weight, in particular, from 20 to 22% by weight, of bound water.

It will be appreciated that it is also possible to use the commonly known phosphates as builder substances, provided that such a use should not be avoided for ecological reasons. Suitable phosphates are in particular, the sodium salts of the orthophosphates, of the pyrophosphates and especially of the tripolyphosphates.

Organic builder substances which can be used are, for example, the polycarboxylic acids usable in the form of their sodium salts, polycarboxylic acids being understood to mean those carboxylic acids which bear more than one acid function. For example, these are citric acid, adipic acid, succinic acid, glutaric acid, malic acid, tartaric acid, maleic acid, fumaric acid, sugar acids, aminocarboxylic acids, nitrilotriacetic acid (NTA), provided that such a use is not objectionable for ecological reasons, and mixtures thereof. Preferred salts are the salts of the polycarboxylic acids such as citric acid, adipic acid, succinic acid, glutaric acid, tartaric acid, sugar acids and mixtures thereof. The acids themselves may also be used. In addition to their builder action, the acids typically also have the property of an acidifying component and thus also serve to establish a lower and milder pH of washing or cleaning compositions. Mention should be made here in particular, of citric acid, succinic acid, glutaric acid, adipic acid, gluconic acid and any mixtures thereof. Suitable builders are also polymeric polycarboxylates; these are, for example, the alkali metal salts of polyacrylic acid or of polymethacrylic acid, for example, those having a relative molecular mass of from 500 to 70,000 g/mol. In the context of the present document, the molar masses reported for polymeric polycarboxylates are weight-average molar masses Mw of the particular acid form, which can in principle be determined by means of gel permeation chromatography (GPC) using a UV detector. The measurement is effected against an external polystyrene standard which, owing to its structural relationship with the polymers investigated, provides realistic molar mass values. These data deviate significantly from the molar mass data for which polystyrenesulfonic acids are used as the standard, the molar masses measured against polystyrenesulfonic acids generally being significantly higher. Suitable polymers are in particular, polyacrylates which preferably have a molecular mass of from 2,000 to 20,000 g/mol. Owing to their superior solubility, the short-chain polyacrylates which have molar masses of from 2,000 to 10,000 g/mol and more preferably of from 3,000 to 5,000 g/mol may in turn be preferred from this group. Also suitable are copolymeric polycarboxylates, especially those of acrylic acid with methacrylic acid and of acrylic acid or methacrylic acid with maleic acid. Particularly suitable copolymers have been found to be those of acrylic acid with maleic acid which contain from 50 to 90% by weight of acrylic acid and from 50 to 10% by weight of maleic acid. Their relative molecular mass, based on free acids, is generally from 2,000 to 70,000 g/mol, preferably from 20,000 to 50,000 g/mol and in particular, from 30,000 to 40,000 g/mol. To improve the water solubility, the polymers may also contain allylsulfonic acids, for example, allyloxybenzenesulfonic acid and methallylsulfonic acid known from European patent EP 0 727 448 B1, as monomers. Special preference is also given to biodegradable polymers composed of more than two different monomer units, for example, those which, according to German Patent Application DE 43 00 772 A1, contain salts of acrylic acid and of maleic acid and vinyl alcohol or vinyl alcohol derivatives as monomers, or, according to German Patent Application DE 42 21 381, contain salts of acrylic acid and of 2-alkylallylsulfonic acid and also sugar derivatives as monomers. Further preferred copolymers are those which are described in German Patent Applications DE-A-43 03 320 and DE-A-44 17 734 and which have, respectively, as monomers, preferably acrolein and acrylic acid/acrylic acid salts, and acrolein and vinyl acetate. As further preferred organic builder substances, mention should likewise be made of polymeric aminodicarboxylic acids, salts thereof or precursor substances thereof. Particular preference is given to polyaspartic acids or salts and derivatives thereof, which are disclosed by German Patent Application DE 195 40 086 A1 to have not only cobuilder properties but also bleach-stabilizing action. Further suitable builder substances are polyacetals which can be obtained by reacting dialdehydes with polyolcarboxylic acids which have from 5 to 7 carbon atoms and at least 3 hydroxyl groups, for example, as described in European Patent Application EP 0 280 223. Preferred polyacetals are obtained from dialdehydes such as glyoxal, glutaraldehyde, terephthalaldehyde and mixtures thereof, and from polyolcarboxylic acids such as gluconic acid and/or glucoheptonic acid. Further suitable organic builder substances are dextrins, for example, oligomers or polymers of carbohydrates which can be obtained by partial hydrolysis of starches. The hydrolysis can be carried out by customary processes, for example, acid- or enzyme-catalyzed processes. The hydrolysis products preferably have mean molar masses in the range from 400 to 500,000 g/mol. Preference is given to a polysaccharide having a dextrose equivalent (DE) in the range from 0.5 to 40, in particular, from 2 to 30, DE being a useful measure for the reducing action of a polysaccharide in comparison to dextrose, which has a DE of 100. Useful polysaccharides are both maltodextrins having a DE between 3 and 20 and dry glucose syrups having a DE between 20 and 37, and so-called yellow dextrins and white dextrins having higher molar masses in the range from 2,000 to 30,000 g/mol. A preferred dextrin is described in European Patent Application EP 0 703 292 A1. The oxidized derivatives of such dextrins are their reaction products with oxidizing agents which are capable of oxidizing at least one alcohol function of the saccharide ring to the carboxylic acid function. Such oxidized dextrins and processes for their preparation are known, for example, from European Patent Applications EP 0 232 202, EP 0 427 349, EP 0 472 042 and EP 0 542 496, and also International Patent Applications WO 92/18542, WO 93/08251, WO 93/16110, WO 94/28030, WO 95/07303, WO 95/12619 and WO 95/20608. Likewise suitable is an oxidized oligosaccharide according to German Patent Application DE-A-196 00018. A product oxidized on C6 of the saccharide ring may be particularly advantageous. Oxydisuccinates and other derivatives of disuccinates, preferably ethylenediamine disuccinates, are further suitable builder materials. Ethylenediamine N,N′-disuccinate (EDDS), whose synthesis is described, for example, in U.S. Pat. No. 3,158,615, is preferably used in the form of its sodium or magnesium salts. In addition, preference is also given in this context to glyceryl disuccinates and glyceryl trisuccinates, as described, for example, in U.S. Pat. No. 4,524,009, U.S. Pat. No. 4,639,325, in European Patent Application EP-A-0 150 930 and Japanese Patent Application JP 93/339896. Further useful organic builders are, for example, acetylated hydroxycarboxylic acids and salts thereof, which may optionally also be present in lactone form and which contain at least 4 carbon atoms and at least one hydroxyl group, and a maximum of two acid groups. Such builders are described, for example, in International Patent Application WO 95/20029. Builder substances, and among these especially water-soluble materials, are present in inventive compositions preferably in amounts of from 1% by weight to 20% by weight, in particular, from 1% by weight to 8% by weight.

The complexing agents which may be present in the compositions for heavy metals (also known as chelating agents) include in particular, phosphonic acid, aminocarboxylic acids and optionally functionally modified phosphonic acids, for example, hydroxy- or aminoalkanephosphonic acids. The usable aminocarboxylic acids include, for example, nitrilotriacetic acid, methylglycinediacetic acid and diethylenetriaminepentaacetic acid. Useful examples among the phosphonic acids are triphosphonomethylamine, 1-hydroxyethane-1,1-diphosphonic acid (HEDP) or the disodium salt or the tetrasodium salt of this acid, 2-phosphonobutane-1,2,4-tricarboxylic acid or the trisodium salt of this acid, ethylenediaminetetramethylenephosphonic acid (EDTMP), diethylenetriaminepentamethylenephosphonic acid (DTPMP) and higher homologs thereof. The N-oxides corresponding to the nitrogen compounds mentioned may also be used. The usable complexing agents also include ethylenediamine-N,N′-disuccinic acid (EDDA). The complexing agents mentioned in their acid form may be used as such or in the form of their alkali metal salts, especially of the sodium salts. Preference is given to the use of mixtures of aminocarboxylic acids with phosphonic acids. Complexing agents for heavy metals are present in inventive compositions preferably in amounts of from 0.05% by weight to 1% by weight, and they may be present if desired in the first part-composition and/or in the second part-composition.

Examples of useful foam inhibitors which may be used in the inventive compositions include soaps, paraffins or silicone oils. Preference is given to using silicone oils.

Suitable antiredeposition agents, which are also referred to as soil repellents, are, for example, nonionic cellulose ethers such as methylcellulose and methylhydroxypropylcellulose having a proportion of methoxy groups of from 15 to 30% by weight and of hydroxypropyl groups of from 1 to 15% by weight, based in each case on the nonionic cellulose ethers, and also the polymers of phthalic acid and/or terephthalic acid known from the prior art or derivatives thereof, especially polymers of ethylene terephthalates and/or polyethylene glycol terephthalates and/or anionically and/or nonionically modified derivatives thereof. Especially preferred among these are the sulfonated derivatives of phthalic acid and terephthalic acid polymers.

Optical brighteners may be added to the inventive compositions in order to eliminate graying and yellowing of the textiles treated. These substances attach to the fibers and bring about brightening and simulated bleaching action by converting invisible ultraviolet radiation to visible longer-wavelength light, the ultraviolet light absorbed from sunlight being radiated as pale bluish fluorescence and, together with the yellow shade of the grayed or yellowed laundry, giving rise to pure white. Suitable compounds stem, for example, from the substance classes of the 4,4′-diamino-2,2′-stilbenedisulfonic acids (flavonic acids), 4,4′-distyrylbiphenyls, methylumbelliferones, coumarins, dihydroquinolinones, 1,3-diarylpyrazolines, naphthalimides, benzoxazole, benzisoxazole and benzimidazole systems, and the pyrene derivatives substituted by heterocycles. The optical brighteners are used typically in amounts between 0.05 and 0.3% by weight, based on the finished composition.

Graying inhibitors have the task of keeping the soil detached from the fiber suspended in the liquor, this preventing the soil from reattaching. Suitable for this purpose are water-soluble colloids, usually of organic nature, for example, size, gelatin, salts of ether sulfonic acids of starch or of cellulose, or salts of acidic sulfuric esters of cellulose or of starch. Also suitable for this purpose are water-soluble polyamides containing acidic groups. It is also possible to use soluble starch preparations and starch products other than those mentioned above, for example, degraded starch, aldehyde starches, etc. Polyvinylpyrrolidone is also usable. However, preference is given to using cellulose ethers such as carboxymethylcellulose (sodium salt), methylcellulose, hydroxyalkylcellulose and mixed ethers such as methylhydroxyethylcellulose, methylhydroxypropylcellulose, methylcarboxymethylcellulose and mixtures thereof in amounts of from 0.1 to 5% by weight based on the compositions.

Since textile fabrics, especially those made of rayon, viscose, cotton and mixtures thereof, can tend to crease because the individual fibers are sensitive to bending, folding, compressing and crushing transverse to the fiber direction, the inventive compositions may comprise synthetic anticrease agents which, however, are preferably not present in the first part-composition. These include, for example, synthetic products based on fatty acids, fatty acid esters, fatty acid amides, fatty acid alkylol esters, fatty acid alkylolamides or fatty alcohols, which have usually been reacted with ethylene oxide, or products based on lecithin or modified phosphoric esters.

To control microorganisms, the inventive compositions may comprise active antimicrobial ingredients. A distinction is drawn here, depending on the antimicrobial spectrum and mechanism of action, between bacteriostats and bactericides, fungistats and fungicides, etc. Important substances from these groups are, for example, benzalkonium chloride, alkylarylsulfonates, halophenols and phenolmercuric acetate, although it is also possible to dispense entirely with these compounds in the inventive compositions. In order to prevent bacterial contamination under unfavorable storage conditions, it may, however, be advantageous when the second alkaline part-composition comprises a preservative, for which useful substances are not only the active antimicrobial substances mentioned but in particular, also sodium N-hydroxymethylglycinate, 3-iodo-2-propynyl carbamate and/or alkali metal hypochlorite, preferably in amounts of from 0.0001% by weight to 0.05% by weight.

Active thickening ingredients usable in the inventive part-compositions are, for example, those from the class of the polyurethanes, polyacrylates which may also be present in at least partly crosslinked form, polyacrylamides and/or polysaccharides or derivatives thereof. Useful polysaccharidic active thickening ingredients include, in addition to carboxylated and/or alkoxylated cellulose, an optionally modified polymer of saccharides such as glucose, galactose, mannose, gulose, altrose, allose, etc. Preference is given to using a water-soluble xanthan, as is commercially available, for example, under the product names Kelzan®, Rhodopol®, Keltrol® or Rheozan®. Xanthan is understood to mean a polysaccharide which corresponds to that which is obtained from aqueous solutions of glucose or starch by virtue of the bacterial strain Xanthomonas campestris (J. Biochem. Microbiol. Technol. Engineer. Vol. III (1961), p. 51 to 63). It consists essentially of glucose, mannose, glucuronic acid and their acetylation products, and also comprises minor amounts of chemically bound pyruvic acid. It is also possible to use water-soluble polysaccharide derivatives, as are obtainable from the corresponding polysaccharides, for example, by oxyalkylating with, for example, ethylene oxide, propylene oxide and/or butylene oxide, by alkylating with, for example, methyl halides and/or dimethyl sulfate, by acylating with carbonyl halides or by hydrolyzing deacetylation. Active thickening ingredients are present in the inventive compositions, especially in the first H₂O₂-containing part-composition, in amounts of preferably from 0.05% by weight to 2.5% by weight, in particular, from 0.1% by weight to 2% by weight, and the proportion need not be equal in all part-compositions. The first part-composition comprises thickeners in an amount which leads to a viscosity of the first part-composition in the range from 20 mPa.s to 150 mPa.s, in particular, from 40 mPa.s to 70 mPa.s (measured at 20° C. with the aid of a customary rotary viscometer, 20 revolutions per minute). When the viscosity of the second part-composition is outside the range specified for the first part-composition, it is preferably lower, but it can, if desired, assume values in the range of in particular, from 5 mPa.s to 250 mPa.s.

The individual part-compositions, especially when only two are present, are preferably employed in equal quantitative proportions. This can be achieved in a simple manner by adjusting the viscosity of the part-compositions and/or the type of outflow orifices of the chambers of the dispenser bottle, in particular, the adjustment to the diameter of the outflow orifices, so that the user of the composition obtains, by simply pouring out or pressing out of the dispenser bottle, an amount usable directly, for example, the amount needed for a washing cycle in a washing machine, of liquid washing composition.

### EXAMPLE 1

Simple mixing of the ingredients specified in the table below in the amounts specified (in percent by weight based on the particular part-composition) prepared part-compositions T1 (pH 5.2, viscosity 40 mPas) and T2 (pH 11.2). These were transferred into one chamber each of a polyethylene dispenser bottle consisting of two equally large chambers (volume in each case 750 ml).

TABLE
Part-compositions [% by weight]

| | T1 | T2 |
|---|---|---|
| Hydrogen peroxide | 7.5 | — |
| Nonionic surfactant^{a)} | 0.5 | — |
| Anionic surfactant^{b)} | 2 | — |
| Sodium carbonate | — | 2.5 |
| NaOH | — | 0.06 |
| Sodium citrate | — | 0.2 |
| Phosphonate^{c)} | 0.15 | 0.001 |
| Aminocarboxylate^{d)} | 0.3 | — |
| Free-radical scavenger^{e)} | 0.03 | — |
| Sodium hypochlorite | — | 0.0005 |
| Ethanol | 2 | — |
| Xanthan | 0.1 | — |
| Polydimethylsiloxane | 0.015 | — |
| Dyes and fragrances | 0.05 | — |
| Water | to 100 | to 100 |

^{a)}C₁₂₋₁₄ fatty alcohol, 4-tuply propoxylated and 5-tuply ethoxylated
^{b)}C₁₂₋₁₄ fatty alcohol plus 2 EO sulfate triethanolamine salt
^{c)}Hydroxyethanediphosphonic acid (Turpinal ® SL)
^{d)}Methylglycinediacetic acid trisodium salt
^{e)}Butylhydroxytoluene

### EXAMPLE 2

Instead of the part-composition T2 mentioned in example 1, the part-composition T1 was combined with a 5 percent by weight aqueous solution of triethanolamine (T3; pH 10.9), with a 5 percent by weight aqueous solution of monoethanolamine (T4; pH 11.7) or an aqueous solution which had been obtained by dissolving 3% by weight of monoethanolamine and 1% by weight of citric acid (T5; pH 10.2) in the double-chamber bottle as in example 1. After exit from the expulsion nozzles, directly after mixing of the two part-compositions, pH values of the mixtures of 9.2 (T1+T3), 10.2 (T1+T4) and 9.8 (T1+T5) resulted.

1. A dispenser bottle for a liquid aqueous washing composition which consists of at least two part-compositions kept separate from one another, wherein the dispenser bottle has a first receiving vessel (1) and at least one second receiving vessel (2) and the first receiving vessel (1) contains a first part-composition and the second receiving vessel (2) a second part-composition, the two receiving vessels (1, 2) either being designed separately or connected to one another or designed together in one piece, the receiving vessels (1, 2) each having an outlet (3, 4) for the part-composition and the outlets (3, 4) being arranged adjacently to one another such that the two part-compositions can be applied in a common application field (5) of an application region, the outlets (3, 4) each further being equipped with at least one expulsion nozzle (6, 7), so that the part-compositions are not mixed with one another until after they leave the expulsion nozzles (6, 7), and are characterized in that the first part-composition comprises water, hydrogen peroxide and surfactant and has an acidic pH and the second part-composition has an alkaline pH.

2. The dispenser bottle as claimed in claim 1, characterized in that the receiving vessels (1, 2) are designed as compressible containers.

3. The dispenser bottle as claimed in claim 2, characterized in that the receiving vessels (1, 2) consist of a material with resilient characteristics and have a shape which supports reset to the original shape.

4. The dispenser bottle as claimed in claim 1, characterized in that the receiving vessels (1, 2) consist of a polymer material.

5. The dispenser bottle as claimed in claim 4, characterized in that the material of the receiving vessels (1, 2) is a polyolefin.

6. The dispenser bottle as claimed in claim 1, characterized in that the receiving vessels (1, 2) have equal volumes and/or an identical shape.

7. The dispenser bottle as claimed in claim 1, characterized in that the receiving vessels (1, 2) are designed as in each case complete containers and are only connected to one another via at least one connecting element (8) formed between the receiving vessels (1, 2), the one connecting element (8) preferably being arranged in about the middle and extending essentially—optionally with interruptions—over the full length of the receiving vessels (1, 2).

8. The dispenser bottle as claimed in claim 1, characterized in that the receiving vessels (1, 2) designed together in one-piece form and preferably produced in a blow-molding process have different transparency and/or different color.

9. The dispenser bottle as claimed in claim 1, characterized in that the receiving vessels (1, 2) each have a cross-section that can be grasped, at least for the most part, by the hand of a user.

10. The dispenser bottle as claimed in claim 9, characterized in that the cross-section comprises a holding region (9) to be grasped by the hand of a user that is formed and/or indicated by special edge moldings (10, 11) and/or surface configurations on the receiving vessels (1, 2).

11. The dispenser bottle as claimed in claim 9, characterized in that the receiving vessels (1, 2) have, in cross-section, in the holding region (9) to be grasped by the hand of a user, an outer circumference of from approx. 18 to approx. 30 cm.

12. The dispenser bottle as claimed in claim 1, characterized in that the shape and the dimensions of the expulsion nozzles (6; 7) and the properties of the active substance fluids are adjusted relative to one another such that—with average pressure from the hand of a user and/or by virtue of gravity—the fluid streams overlap at a certain, pre-calculated distance.

13. The dispenser bottle as claimed in claim 12, characterized in that the fluid streams overlap at a distance of from about 50 mm to about 300 mm.

14. The dispenser bottle as claimed in claim 1, characterized in that the outlets (3; 4) are aligned so as to be inclined toward one another.

15. The dispenser bottle as claimed in claim 1, characterized in that the expulsion nozzle (6; 7) is shaped integrally at the outlet (3; 4) on the receiving vessel (1; 2).

16. The dispenser bottle as claimed in claim 1, characterized in that the expulsion nozzle (6; 7) is arranged or shaped in a separate nozzle head (12) and the nozzle head (12) is attached to the receiving vessel (1; 2) at the outlet (3; 4).

17. The dispenser bottle as claimed in claim 16, characterized in that the nozzle head (12) is snap-fitted to the receiving vessel (1; 2).

18. The dispenser bottle as claimed in claim 16, characterized in that the nozzle heads (12) of the two receiving vessels (1; 2) are combined in a common nozzle head (12).

19. The dispenser bottle as claimed in claim 16, characterized in that the expulsion nozzle (6; 7) is arranged asymmetrically in the nozzle head (12), with respect to the center line of the outlet (3; 4).

20. The dispenser bottle as claimed in claim 16, characterized in that the nozzle head (12) has an inflow volume (13) narrowing from the outlet (3; 4) of the receiving vessel (1; 2) toward the expulsion nozzle (6; 7).

21. The dispenser bottle as claimed in claim 1, characterized in that the lateral midpoint separation of the expulsion nozzles (6; 7) externally is from about mm to about 30 mm.

22. The dispenser bottle as claimed in claim 1, characterized in that the expulsion nozzle (6; 7) can be closed with a removable closure cap (14).

23. The dispenser bottle as claimed in claim 22, characterized in that the closure cap (14) has a closure stopper (15) which enters into the expulsion nozzle (6; 7).

24. The dispenser bottle as claimed in claim 23, characterized in that the closure cap (14) has laterally, in addition to the closure stopper (15) entering into the expulsion nozzle (6; 7), a cylinder section (19) arranged convex to the longitudinal axis of the closure cap (14) as a positioning aid, the cylinder section (19) being spaced apart from the closure stopper (15) such that the free ends of the cylinder section (19) adjoin the expulsion nozzles (6, 7) in closure position.

25. The dispenser bottle as claimed in claim 22, characterized in that the closure caps (14) of the two expulsion nozzles (6; 7) are combined in a common closure cap (14).

26. The dispenser bottle as claimed in claim 1, characterized in that the nozzle channels (16; 17) of the expulsion nozzles (6; 7) are inclined toward one another.

27. The dispenser bottle as claimed in claim 1, characterized in that the nozzle channels (16; 17) of the expulsion nozzles (6; 7) are aligned essentially parallel to one another.

28. The dispenser bottle as claimed in claim 26, characterized in that the nozzle channels (16; 17) of the expulsion nozzles (6; 7) each have a cross-sectional constriction (18) arranged asymmetrically to the overall flow cross-section.

29. The dispenser bottle as claimed in claim 28, characterized in that the cross-sectional constriction (18) of the nozzle channel (16; 17) is designed with angular transitions.

30. The dispenser bottle as claimed in claim 28, characterized in that the cross-sectional constrictions (18) are arranged on the sides of the nozzle channels (16; 17) facing one another, in such a way that the streams of the active substance fluids exiting under pressure have such a swirl that they run toward one another.

31. The dispenser bottle as claimed in claim 28, characterized in that the cross-sectional constriction (18) is designed as a circle section, or as a geometric figure projecting inward, or in an inwardly curved manner.

32. The dispenser bottle as claimed in claim 28, characterized in that the length of the cross-sectional constriction (18) of the nozzle channel (16; 17) is only part of the length of the nozzle channel (16; 17) as a whole.

33. The dispenser bottle as claimed in claim 32, characterized in that the length ratio is from about 1:2 to about 1:4.

34. The dispenser bottle as claimed in claim 1, characterized in that the total length of the nozzle channel (16; 17) is from about 2 to about 6 mm.

35. The dispenser bottle as claimed in claim 1, characterized in that the nozzle channel (16; 17) is canted at its end, the opening plane of the nozzle channel (16; 17) being arranged such that the inner section of the wall (20) with respect to the longitudinal axis of the nozzle channel (16; 17) is longer than the outer section of the wall (20) with respect to the longitudinal axis of the nozzle channel (16; 17).

36. The dispenser bottle as claimed in claim 1, characterized in that the diameter of the nozzle channel (16; 17) is from about 1.0 mm to about 4.0 mm.

37. A dispenser bottle for a liquid aqueous washing composition which consists of at least two part-compositions kept separate from one another, wherein the dispenser bottle has a first receiving vessel (1) and at least one second receiving vessel (2) and the first receiving vessel (1) contains a first part-composition and the second receiving vessel (2) a second part-composition, the two receiving vessels (1, 2) either being designed separately or connected to one another or designed together in one piece, the receiving vessels (1, 2) each having an outlet (3, 4) for the part-composition and the outlets (3, 4) being arranged adjacently to one another such that the two part-compositions can be applied in a common application field (5) of an application region, the outlets (3, 4) each further being equipped with at least one expulsion nozzle (6, 7), so that the part-compositions are not mixed with one another until after they leave the expulsion nozzles (6, 7), and are characterized in that the first part-composition comprises 50% by weight to 95% by weight water, 1.5% by weight to 15% by weight hydrogen peroxide and 1% by weight to 20% by weight surfactant and has an acidic pH and the second part-composition has an alkaline pH.

38. The dispenser bottle as claimed in claim 1, characterized in that the first part-composition contains from about 1.5% by weight to 10% by weight, of nonionic surfactant and/or anionic surfactant, from 60% by weight to 90% by weight of water, and has a pH in the range from 3.5 to below 7.

39. The dispenser bottle as claimed in claim 37, characterized in that the first part-composition additionally comprises at least one chelating agent, water-miscible solvent, free-radical scavenger, dye and fragrance.

40. The dispenser bottle as claimed in claim 37, characterized in that the first part-composition additionally comprises thickener in an amount which leads to a viscosity of the first part-composition in the range from 20 mPa.s to 150 mPa.s (20° C., rotary viscometer, 20 revolutions per minute).

41. The dispenser bottle as claimed in claim 1, characterized in that the water content of the second part-composition is up to 99.95% by weight and that the second part-composition has a pH in the range from 9.5 to 13.5.

42. The dispenser bottle as claimed in claim 1, characterized in that the second part-composition is anhydrous and contains such an amount of substances alkaline in water that, after mixing with the first part-composition in a volume ratio of 1:1, the resulting pH is at least 1 unit above that of the first part-composition.

43. A process for the application of a liquid aqueous washing composition to textiles, said process comprising the step of applying the liquid aqueous washing composition from a dispenser bottle which consists of at least two part-compositions kept separate from one another, wherein the dispenser bottle has a first receiving vessel (1) and at least one second receiving vessel (2) and the first receiving vessel (1) contains a first part-composition and the second receiving vessel (2) a second part-composition, the two receiving vessels (1, 2) either being designed separately or connected to one another or designed together in one piece, the receiving vessels (1, 2) each having an outlet (3, 4) for the part-composition and the outlets (3, 4) being arranged adjacently to one another such that the two part-compositions can be applied in a common application field (5) of an application region, the outlets (3, 4) each further being equipped with at least one expulsion nozzle (6, 7), so that the part-compositions are not mixed with one another until after they leave the expulsion nozzles (6, 7), and are characterized in that the first part-composition comprises water, hydrogen peroxide and surfactant and has an acidic pH and the second part-composition has an alkaline pH.
